(19) United States
(12) Patent Application Publication
(10) Pub. No.: US 2012/0317066 A1
(43) Pub. Date: Dec. 13, 2012

(54) INTEREST LEVEL MEASUREMENT SYSTEM, INTEREST LEVEL MEASUREMENT DEVICE, INTEREST LEVEL MEASUREMENT METHOD, AND INTEREST LEVEL MEASUREMENT PROGRAM

(75) Inventor: Yoji Miyazaki, Minato-ku (JP)

(73) Assignee: NEC CORPORATION, Tokyo (JP)

(21) Appl. No.: 13/579,500

(22) PCT Filed: Feb. 17, 2011
(86) PCT No.: PCT/JP2011/000879

§ 371 Date: Aug. 16, 2012

(30) Foreign Application Priority Data
Mar. 16, 2010 (JP) 2010-059750

(51) Int. Cl. G06N 5/02

(52) U.S. Cl. 706/46

(57) ABSTRACT

Data that indicates an action state of a user is acquired by a user terminal. Area stay information that includes position information of an area in which the user stays and stay time information of a time during which the user stays in the area is acquired. The data acquired by the user terminal is stored, and the stored data is read according to the acquired area stay information. A behavior status of the user is determined based on the read data, and a behavior status time-series pattern that indicates the behavior status of the user is created. A behavior feature value that indicates a feature of a behavior of the user is calculated based on the created behavior status time-series pattern. An area interest level that indicates a degree and tendency of the user's interest in the area is determined using the calculated behavior feature value.

### TECHNICAL FIELD

The present invention relates to an interest level measurement system, an interest level measurement device, an interest level measurement method, and an interest level measurement program for measuring a user's interest level in an area.

### BACKGROUND ART

Service of providing information of high interest to a user more efficiently by estimating the user's object of interest through the use of the user's behavior history and selecting information to be distributed based on the estimation result is widely available. However, such service is limited to information provision based on the estimation of the user's interest using only behavior information which can be acquired easily, such as a Web page browsing history. This raises a need for a technique by which real-world human behavior information can also be acquired and the user's interest can be recognized based on the acquired information.

For example, Patent Literature (PTL) 1 describes a system in which information indicating human behavior in the real world is acquired using a sensor and users' interest level is calculated based on the acquired data. In the system described in PTL 1, a plurality of users' interest level is quantified by detecting their walking and stopping. In detail, in the system described in PTL 1, the number of people stopping in an area in a certain time is counted based on information acquired using an accelerometer carried by each user, a camera installed at each place, or the like. The plurality of users' interest level is then calculated on an assumption that the degree of people's interest in the area is higher when more people stop in the area.

### CITATION LIST

### Patent Literature(s)

PTL 1: Japanese Patent Application Laid-Open No. 2007-114988 (paragraphs 0166 to 0170)

### SUMMARY OF INVENTION

### Technical Problem

FIG. 34 is a block diagram showing an example of a structure of an interest level measurement system for measuring a plurality of users' interest level as described in PTL 1. As shown in FIG. 34, the interest level measurement system includes sensor terminals, a sensor data reception/collection unit, a walking/stopping determination unit, an area information acquisition unit, an area stay head-count calculation unit, an area interest level calculation unit, and an interest level output device.

The sensor terminals have a function of collecting information relating to walking/stopping of the users. The sensor data reception/collection unit has a function of receiving/collecting sensor data. The walking/stopping determination unit has a function of determining walking/stopping of people in an area, based on the obtained sensor data. The area information acquisition unit has a function of acquiring a position of the area. The area stay head-count calculation unit has a function of counting the number of people stopping in the area per unit time. The area interest level calculation unit has a function of calculating people's interest level in the area from the number of people staying. The interest level output device has a function of outputting interest level information based on the interest level in the area, to a content server for creating distribution content and the like.

However, the interest level measurement system as described in PTL 1 can merely macroscopically analyze the degree and tendency of people's interest in the area by counting the number of users stopping in the area. Thus, there is a problem that it is impossible to finely recognize the degree and tendency of interest that differs depending on the user by detecting the detailed behavior status of the user including not only a walking state and a stopping state but also a squatting state, a stretching state, and so on.

In detail, in the interest level measurement system as described in PTL 1, the interest level is calculated based only on the number of people stopping in the area in the certain time. Since the interest level can merely be calculated based only on the number of people stopping in the area in the certain time, even in the case where each user stopping in the area has a different degree of interest, the interest level cannot be measured individually on a user basis. Accordingly, it is impossible to determine whether or not the calculated interest level can serve as an index applicable to all people. For instance, in the case of offering service such as information distribution, information distributed based on such an interest level is not necessarily useful for a user who receives the information.

In view of this, an exemplary object of the present invention is to provide an interest level measurement system, an interest level measurement device, an interest level measurement method, and an interest level measurement program capable of recognizing the detailed behavior status of the user to calculate the fine interest level in each area by taking into account the degree and tendency of interest on a user basis.

### Solution to Problem

An interest level measurement system according to an exemplary aspect of the present invention comprises: a user terminal for acquiring data that indicates an action state of a user; area stay information acquisition means for acquiring area stay information that includes position information of an area in which the user stays and stay time information of a time during which the user stays in the area; data storage/reading means for storing the data acquired by the user terminal, and reading the stored data according to the area stay information acquired by the area stay information acquisition means; behavior status time-series pattern creation means for determining a behavior status of the user based on the data read by the data storage/reading means, and creating a behavior status time-series pattern that indicates the behavior status of the user; behavior feature value calculation means for calculating a behavior feature value that indicates a feature of a behavior of the user, based on the behavior status time-series pattern created by the behavior status time-series pattern creation means; and area interest level determination means for determining an area interest level that indicates a degree and tendency of the user's interest in the area, using the behavior feature value calculated by the behavior feature value calculation means.

An interest level measurement device according to an exemplary aspect of the present invention comprises: area stay information acquisition means for acquiring area stay information that includes position information of an area in which a user stays and stay time information of a time during which the user stays in the area; data storage/reading means for storing data acquired by a user terminal and indicating an action state of the user, and reading the stored data according to the area stay information acquired by the area stay information acquisition means; behavior status time-series pattern creation means for determining a behavior status of the user based on the data read by the data storage/reading means, and creating a behavior status time-series pattern that indicates the behavior status of the user; behavior feature value calculation means for calculating a behavior feature value that indicates a feature of a behavior of the user, based on the behavior status time-series pattern created by the behavior status time-series pattern creation means; and area interest level determination means for determining an area interest level that indicates a degree and tendency of the user's interest in the area, using the behavior feature value calculated by the behavior feature value calculation means.

An interest level measurement method according to an exemplary aspect of the present invention comprises: acquiring, by a user terminal, data that indicates an action state of a user; acquiring area stay information that includes position information of an area in which the user stays and stay time information of a time during which the user stays in the area; storing the data acquired by the user terminal, and reading the stored data according to the acquired area stay information; determining a behavior status of the user based on the read data, and creating a behavior status time-series pattern that indicates the behavior status of the user; calculating a behavior feature value that indicates a feature of a behavior of the user, based on the created behavior status time-series pattern; and determining an area interest level that indicates a degree and tendency of the user's interest in the area, using the calculated behavior feature value.

An interest level measurement program according to an exemplary aspect of the present invention causes a computer to execute: a process of acquiring area stay information that includes position information of an area in which a user stays and stay time information of a time during which the user stays in the area; a process of storing data acquired by a user terminal and indicating an action state of the user, and reading the stored data according to the acquired area stay information; a process of determining a behavior status of the user based on the read data, and creating a behavior status time-series pattern that indicates the behavior status of the user; a process of calculating a behavior feature value that indicates a feature of a behavior of the user, based on the created behavior status time-series pattern; and a process of determining an area interest level that indicates a degree and tendency of the user's interest in the area, using the calculated behavior feature value.

### Advantageous Effects of Invention

According to the present invention, the detailed behavior status of the user can be recognized to calculate the fine interest level in each area by taking into account the degree and tendency of interest on a user basis.

### BRIEF DESCRIPTION OF DRAWINGS

FIG. 1 is a block diagram showing an example of a structure of an interest level measurement system according to the present invention.

FIG. 2 is a flowchart showing an example of a process of measuring an interest level in an area on a user basis in the interest level measurement system.

FIG. 3 is a block diagram showing an example of a structure of an interest level measurement system in Exemplary Embodiment 2.

FIG. 4 is a flowchart showing an example of a process of measuring an interest level in an area on a user basis in the interest level measurement system in Exemplary Embodiment 2.

FIG. 5 is a block diagram showing an example of a structure of an interest level measurement system in Exemplary Embodiment 3.

FIG. 6 is a flowchart showing an example of a process of measuring an interest level in an area on a user basis in the interest level measurement system in Exemplary Embodiment 3.

FIG. 7 is a block diagram showing an example of a structure of an interest level measurement system in Exemplary Embodiment 4.

FIG. 8 is a flowchart showing an example of a process of measuring an interest level in an area on a user basis in the interest level measurement system in Exemplary Embodiment 4.

FIG. 9 is an explanatory diagram showing an example of a relationship between behavior feature values and user interest levels obtained from a result of an experiment conducted beforehand.

FIG. 10 is a block diagram showing an example of a structure of an interest level measurement system in Exemplary Embodiment 5.

FIG. 11 is a flowchart showing an example of a process of measuring an interest level in an area on a user basis in the interest level measurement system in Exemplary Embodiment 5.

FIG. 12 is a block diagram showing an example of a structure of an interest level measurement system in Exemplary Embodiment 6.

FIG. 13 is a flowchart showing an example of a process of measuring an interest level in an area on a user basis in the interest level measurement system in Exemplary Embodiment 6.

FIG. 14 is an explanatory diagram showing a graph of acceleration data obtained using the user's mobile phone from when the user enters a store to when the user leaves the store.

FIG. 15 is an explanatory diagram showing a graph of a variance calculated from acceleration per second using the data shown in FIG. 14.

FIG. 16 is an explanatory diagram showing a graph of a result of determining a walking state and a stopping state from the variance using the data shown in FIG. 15, where the walking state is set to 1 and the stopping state is set to 0.

FIG. 17 is an explanatory diagram showing an example of a determination algorithm according to which an interest level measurement device determines whether the user is in a walking state, a stopping state, or a state of a non-walking behavior.

FIG. 18 is an explanatory diagram showing a specific example of an acceleration peak interval determination method.

FIG. 19 is an explanatory diagram showing a specific example of a determination result of determining whether or not the user is in a state of a non-walking behavior through actual acceleration measurement.

FIG. 20 is an explanatory diagram showing another example of a relationship between behavior feature values and user interest levels obtained from a result of an experiment conducted beforehand.

FIG. 21 is an explanatory diagram showing an investigation result obtained by plotting an interest level defined based on a survey result and an estimated interest level.

FIG. 22 is an explanatory diagram showing a specific example of a display screen displayed based on an interest level determination result.

FIG. 23 is an explanatory diagram showing a specific example of a display screen displayed based on an interest level determination result.

FIG. 24 is an explanatory diagram showing another example of a relationship between behavior feature values and user interest levels obtained from a result of an experiment conducted beforehand.

FIG. 25 is an explanatory diagram showing another example of a relationship between behavior feature values and user interest levels obtained from a result of an experiment conducted beforehand.

FIG. 26 is an explanatory diagram showing another example of a relationship between behavior feature values and user interest levels obtained from a result of an experiment conducted beforehand.

FIG. 27 is an explanatory diagram showing another example of a relationship between behavior feature values and user interest levels obtained from a result of an experiment conducted beforehand.

FIG. 28 is an explanatory diagram showing another example of a relationship between behavior feature values and user interest levels obtained from a result of an experiment conducted beforehand.

FIG. 29 is an explanatory diagram showing a graph of a walking/stopping time-series pattern stored as history information when the user stayed in the store in the past.

FIG. 30 is an explanatory diagram showing an example of a relationship between past behavior feature values of the user and latest interest level feature values obtained from a result of an experiment conducted beforehand.

FIG. 31 is an explanatory diagram showing an example of comparing, between different users, a relationship between behavior feature values and interest levels obtained from a result of an experiment conducted beforehand.

FIG. 32 is an explanatory diagram showing a graph of a walking/stopping time-series pattern stored as history information when a user B stayed in the store.

FIG. 33 is a block diagram showing an example of a minimum structure of an interest level measurement system.

FIG. 34 is a block diagram showing an example of a structure of an interest level measurement system.

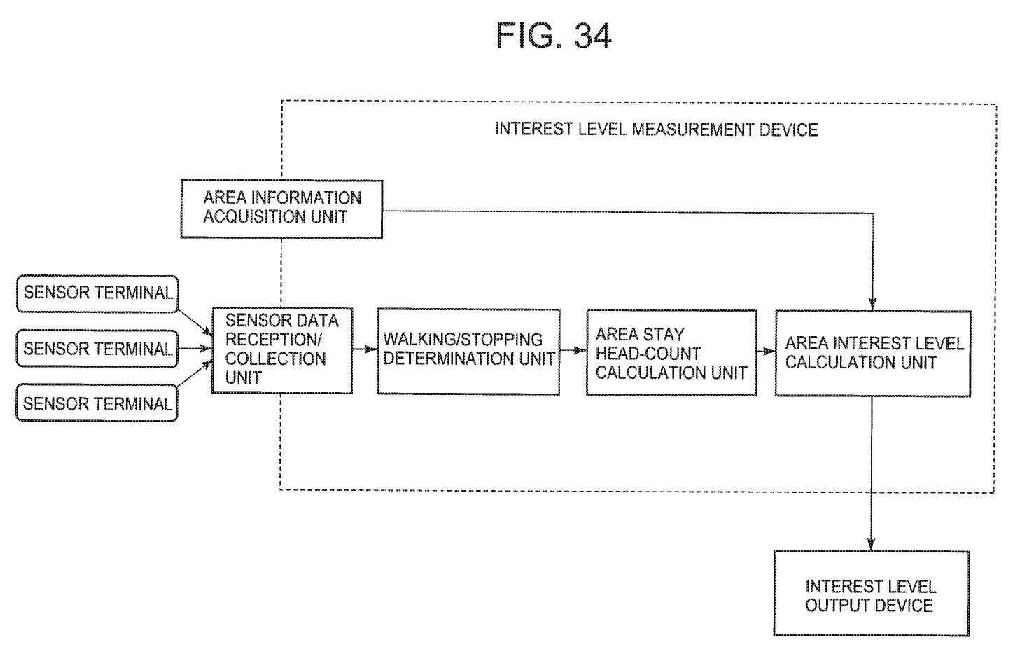

### DESCRIPTION OF EMBODIMENT(S)

The following describes exemplary embodiments of the present invention with reference to drawings. An interest level measurement system according to the present invention can quantify, through the use of an individual user's walking/stopping time-series pattern of walking/stopping actions and non-walking behavior time-series pattern or terminal posture time-series pattern, a behavior feature value representing the way of having interest that differs depending on the user, thereby calculating a fine interest level in each area by taking into account the degree and tendency of interest on a user basis.

The interest level measurement system according to the present invention includes: a sensor data reception unit for receiving sensor data acquired using a sensor; an area information acquisition/notification unit for acquiring position information of an area in which the user stays and stay time information; a walking/stopping pattern creation unit for determining whether the user is in a walking state or a stopping state based on the sensor data and creating a walking/stopping time-series pattern; a non-walking behavior pattern creation unit for determining whether or not the user is in a state of a behavior other than walking and creating a non-walking behavior time-series pattern, or a terminal posture pattern creation unit for determining a posture of a user terminal and creating a terminal posture time-series pattern; a behavior feature value calculation unit for calculating a feature value indicating the user's interest based on the obtained walking/stopping time-series pattern and non-walking behavior time-series pattern or terminal posture time-series pattern; and an area interest level determination unit for determining the user's interest level in the area based on the behavior feature value calculated by the behavior feature value calculation unit.

According to this structure, the feature value indicating the degree and tendency of interest is calculated based on the individual user's walking/stopping time-series pattern and non-walking behavior time-series pattern or terminal posture time-series pattern. This enables, for example, the detailed behavior status of the user to be recognized so that the characteristics of the user's interest in the area, such as the purpose of visiting the store, the number of products the user is interested in, and the degree of interest, can be recognized more finely. Hence, the exemplary object of the present invention can be achieved.

Example uses of the interest level measurement system according to the present invention include: selectively distributing only information interesting to the user; the store acquiring interest level information and using it as data for seeking a more attractive selling space; and sharing interest level information with others to find the tendency of the user's interest which he/she has been unaware of.

### Exemplary Embodiment 1

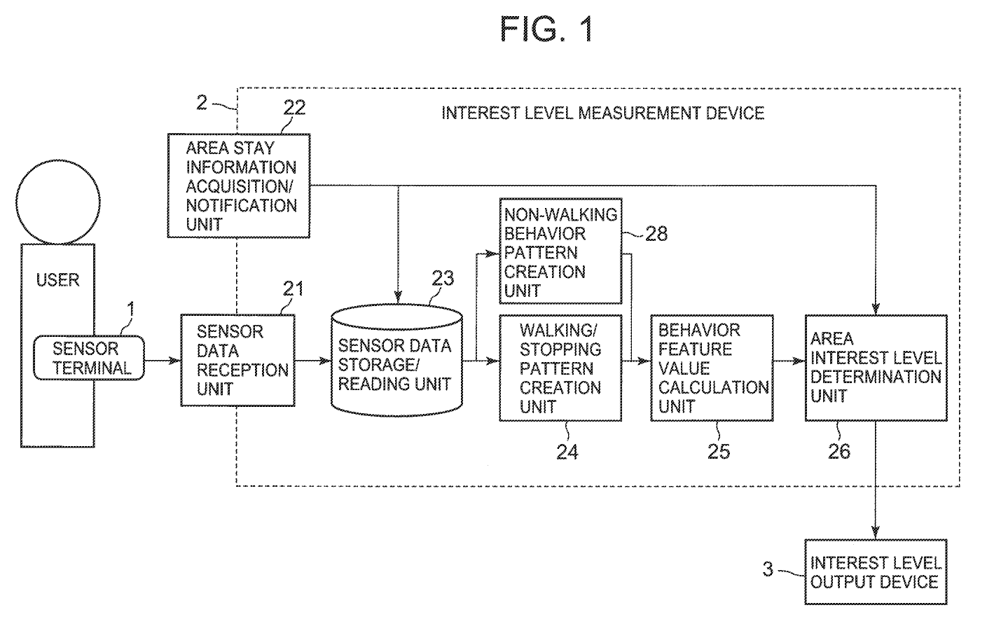

Exemplary Embodiment 1 of the present invention is described below, with reference to drawings. FIG. 1 is a block diagram showing an example of a structure of an interest level measurement system according to the present invention. As shown in FIG. 1, the interest level measurement system in this exemplary embodiment includes a sensor terminal 1, an interest level measurement device 2, and an interest level output device 3.

The sensor terminal 1 includes a sensor for acquiring information relating to human walking/stopping actions and behaviors other than walking (hereafter referred to as non-walking behaviors). The sensor terminal 1 has a function of transmitting sensor time-series data acquired using the sensor, to the interest level measurement device 2. As an example, the sensor terminal 1 is realized by a mobile terminal such as a mobile phone equipped with an accelerometer. In this case, the sensor terminal 1 transmits time-series data (hereafter also referred to as sensor time-series data) of acceleration detected by the accelerometer to the interest level measurement device 2 via a communication network including a mobile phone network, as information relating to walking/stopping actions of a user who carries the sensor terminal 1 (mobile phone).

The interest level measurement device 2 is, for instance, a device operated by a communication carrier or a service provider providing interest level measurement service. As an example, the interest level measurement device 2 is realized using an information processing device such as a personal computer operating according to a program. The interest level measurement system including the interest level measurement device 2 may be realized using one mobile terminal (interest level measurement terminal) such as a mobile phone.

As shown in FIG. 1, the interest level measurement device 2 includes a sensor data reception unit 21, an area stay information acquisition/notification unit 22, a sensor data storage/reading unit 23, a walking/stopping pattern creation unit 24, a non-walking behavior pattern creation unit 28, a behavior feature value calculation unit 25, and an area interest level determination unit 26.

The sensor data reception unit 21 has a function of receiving the sensor time-series data acquired by the sensor terminal 1, from the sensor terminal 1 via the communication network. The sensor data reception unit 21 also has a function of supplying (outputting) the received sensor time-series data to the sensor data storage/reading unit 23. For example, in the case where the sensor terminal 1 is realized by a mobile phone, the sensor data reception unit 21 is realized by a base station of the mobile phone, a wireless LAN access point, or the like.

The area stay information acquisition/notification unit 22 has a function of acquiring area stay information that includes a position of an area in which the user stays and a time during which the user stays in the area. The area stay information acquisition/notification unit 22 also has a function of transmitting or outputting the acquired area stay information to the interest level measurement device 2.

For example, in the case where the sensor terminal 1 is a mobile phone, the area stay information acquisition/notification unit 22 uses the following area stay information acquisition method. The area stay information acquisition/notification unit 22 calculates, as a stay time, a time from when the user enters an area of a fixed range to when the user leaves the area, using positioning information received by a GPS receiver equipped in the mobile phone. The area stay information acquisition/notification unit 22 then transmits the calculated area stay information to the interest level measurement device 2 via a communication network. In this case, the area stay information acquisition/notification unit 22 is realized by the GPS receiver, a network interface unit, and a CPU of the mobile phone operating according to a program.

Alternatively, for example, the area stay information acquisition/notification unit 22 stores installation positions of a plurality of sensor data reception units 21 (base stations or access points) installed at various places, in a database beforehand. The area stay information acquisition/notification unit 22 determines position information of a sensor data reception unit 21 used for data reception of sensor time-series data, as the area in which the user stays. The area stay information acquisition/notification unit 22 also calculates a time during which the same sensor data reception unit 21 continuously receives data, as the stay time. The area stay information acquisition/notification unit 22 outputs the calculated area stay information to the interest level measurement device 2. In this case, the area stay information acquisition/notification unit 22 is realized by a network interface unit and a CPU of the information processing device for realizing the interest level measurement device 2.

The area stay information acquisition/notification unit 22 may instead notify (transmit) area stay information explicitly indicating the user's visit to the stay area to the interest level measurement device 2, according to an operation by the user. In this case, the area stay information acquisition/notification unit 22 is realized by the network interface unit and the CPU of the mobile phone operating according to the program.

The area stay information acquisition/notification unit 22 also has a function of notifying (outputting) notification information for instructing the sensor data storage/reading unit 23 to supply (output) the sensor time-series data to the walking/stopping pattern creation unit 24 and the non-walking behavior pattern creation unit 28, upon completion of the area stay time of the user. The area stay information acquisition/notification unit 22 further has a function of simultaneously supplying (outputting) the area stay information to the area interest level determination unit 26.

The sensor data storage/reading unit 23 is actually realized by the CPU of the information processing device operating according to a program and a database device such as a magnetic disk device or an optical disc device. The sensor data storage/reading unit 23 has a function of continuously storing the sensor time-series data received from the sensor data reception unit 21, in the database device. The sensor data storage/reading unit 23 also has a function of, upon reception of the notification information indicating the completion of the area stay time of the user from the area stay information acquisition/notification unit 22, reading the sensor time-series data stored in the database device and supplying (outputting) the read sensor time-series data to the walking/stopping pattern creation unit 24 and the non-walking behavior pattern creation unit 28.

The walking/stopping pattern creation unit 24 is actually realized by the CPU of the information processing device operating according to the program. The walking/stopping pattern creation unit 24 has a function of determining whether the user is in a walking state or a stopping state, based on the sensor time-series data received from the sensor data storage/reading unit 23. The walking/stopping pattern creation unit 24 also has a function of supplying (outputting) a result of the determination to the behavior feature value calculation unit 25 as a walking/stopping time-series pattern.

For instance, in the case where the sensor included in the sensor terminal 1 is an accelerometer, the walking/stopping pattern creation unit 24 calculates a value such as a variance of acceleration per second. The walking/stopping pattern creation unit 24 performs an operation such as comparing magnitudes of the calculated value such as the variance and a preset threshold, to determine whether the user is in a walking state or a stopping state. The walking/stopping pattern creation unit 24 arranges determination results in chronological order to create the walking/stopping time-series pattern.

The non-walking behavior pattern creation unit 28 is actually realized by the CPU of the information processing device operating according to the program. The non-walking behavior pattern creation unit 28 has a function of determining whether or not the user is in a state of a non-walking behavior, based on the sensor time-series data received from the sensor data storage/reading unit 23. The non-walking behavior pattern creation unit 28 also has a function of supplying (outputting) a result of the determination to the behavior feature value calculation unit 25 as a non-walking behavior time-series pattern.

In this embodiment, the term “non-walking behavior” means, for example, a state in which the user is performing a behavior other than walking, such as a state in which the user is seeing a product while taking it in hand, a state in which the user is squatting to see a product, a state in which the user is stooping to see a product, a state in which the user is stretching to see a product, a state in which the user is slowly moving around shelves, and so on.

For example, in the case where the sensor included in the sensor terminal 1 is an accelerometer, the non-walking behavior pattern creation unit 28 determines whether or not the user is in a state of a non-walking behavior, based on a waveform of acceleration received from the sensor terminal 1. For example, the non-walking behavior pattern creation unit 28 calculates an interval at which a peak value (e.g. a maximum value in a region of a range not less than a predetermined threshold in the time-series data) of acceleration in the sensor time-series data appears. In the case where the peak value appearance interval is not more than a predetermined interval, the non-walking behavior pattern creation unit 28 can determine that the user is in a state of a non-walking behavior. Typically, the acceleration peak value interval is long in an acceleration waveform detected in the case where the user is walking, and short in an acceleration waveform detected in the case where the user is performing a non-walking behavior such as stooping or stretching in the same place. Accordingly, the non-walking behavior pattern creation unit 28 can determine that the user is in a state of a non-walking behavior, in the case where the interval at which the acceleration peak value appears is short. The non-walking behavior pattern creation unit 28 arranges determination results in chronological order to create the non-walking behavior time-series pattern.

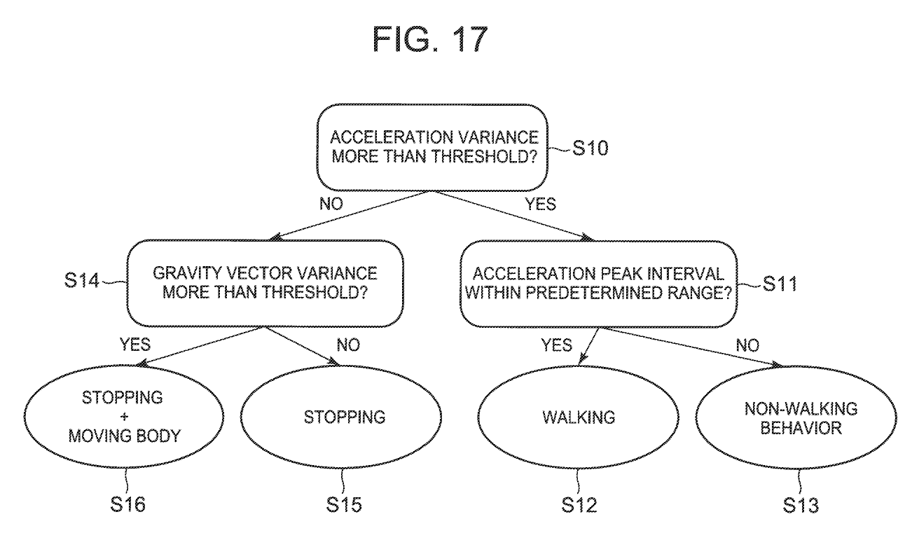

In detail, the interest level measurement device 2 calculates a variance of acceleration based on the received accelerometer time-series data, calculates a variance of a gravity vector based on the acceleration, and determines whether the user is in a walking state, a stopping state, or a state of a non-walking behavior according to an algorithm shown in FIG. 17 described later, by the functions of the walking/stopping pattern creation unit 24 and the non-walking behavior pattern creation unit 28. For example, as shown in FIG. 17 described later, the interest level measurement device 2 determines whether or not the calculated acceleration variance is more than a predetermined threshold and, in the case of determining that the calculated acceleration variance is more than the predetermined threshold, determines whether or not the acceleration peak interval is within a predetermined range, by the functions of the walking/stopping pattern creation unit 24 and the non-walking behavior pattern creation unit 28 (see steps S10 and S11 in FIG. 17). In the case where the acceleration peak interval is within the predetermined range, the interest level measurement device 2 determines that the user is in a walking state, by the functions of the walking/stopping pattern creation unit 24 and the non-walking behavior pattern creation unit 28 (see step S12 in FIG. 17). In the case where the acceleration peak interval is not within the predetermined range, the interest level measurement device 2 determines that the user is in a state of a non-walking behavior, by the functions of the walking/stopping pattern creation unit 24 and the non-walking behavior pattern creation unit 28 (see step S13 in FIG. 17).

In the case where the calculated acceleration variance is not more than the predetermined threshold, on the other hand, the interest level measurement device 2 determines whether or not the calculated gravity vector variance is more than a predetermined threshold and, in the case of determining that the calculated gravity vector variance is not more than the predetermined threshold, determines that the user is in a stopping state, by the functions of the walking/stopping pattern creation unit 24 and the non-walking behavior pattern creation unit 28 (see steps S14 and S15 in FIG. 17). In the case of determining that the calculated gravity vector variance is more than the predetermined threshold, the interest level measurement device 2 determines that the user is in a stopping state but also in a state of moving his/her body in the stopping place, by the functions of the walking/stopping pattern creation unit 24 and the non-walking behavior pattern creation unit 28 (see step S16 in FIG. 17).

The behavior feature value calculation unit 25 is actually realized by the CPU of the information processing device operating according to the program. The behavior feature value calculation unit 25 has a function of calculating a behavior feature value indicating a feature of a behavior of the user, based on the walking/stopping time-series pattern received from the walking/stopping pattern creation unit 24 and the non-walking behavior time-series pattern received from the non-walking behavior pattern creation unit 28. The behavior feature value calculation unit 25 also has a function of outputting the calculated behavior feature value to the area interest level determination unit 26.

For instance, the behavior feature value calculation unit 25 calculates, as a behavior feature value, each of the feature values such as the walking time, the stopping time, and the non-walking behavior time within the time during which the user stays in the area or the total sums or mean values of such times, the ratio between the walking time, the stopping time, and the non-walking behavior time, the walking count, the stopping count, the non-walking behavior count, and the like. The behavior feature value calculation unit 25 supplies (outputs) the calculated behavior feature value to the area interest level determination unit 26.

The area interest level determination unit 26 is actually realized by the CPU of the information processing device operating according to the program. The area interest level determination unit 26 has a function of determining an area interest level indicating the degree of interest in the area on a user basis, using the behavior feature value received from the behavior feature value calculation unit 25 and the area stay information received from the area stay information acquisition/notification unit 22. The area interest level determination unit 26 also has a function of outputting area interest level information indicating the determined area interest level to the interest level output device 3.

For instance, the area interest level determination unit 26 performs an operation such as comparing magnitudes of the behavior feature value received from the behavior feature value calculation unit 25 and a preset threshold. For a user whose stay time in the area is long but whose stopping time is short, the area interest level determination unit 26 determines that the user has a low degree of interest in the area. For a user whose stay time in the area is short but whose stopping time ratio is high, the area interest level determination unit 26 determines that the user is very interested in the area. Moreover, for example in the case where the non-walking behavior time as the behavior feature value is long, the area interest level determination unit 26 can determine that the user is in a state of changing his/her posture or squatting, and so can determine that the user is in a state of being interested in a product on a shelf or the like. Through such determination, the area interest level determination unit 26 determines the user's area interest level in the area, and supplies (outputs) the determination result of the area interest level (area interest level information) to the interest level output device 3.

The interest level output device 3 may actually be realized by the network interface unit and the CPU of the information processing device operating according to the program. The interest level output device 3 is a device for outputting, in a usable form, the area interest level information on a user basis received from the area interest level determination unit 26.

As an example, the interest level output device 3 transmits the obtained area interest level information to a mobile phone possessed by the user, to display the interest level information of the user on a display unit of the mobile phone. As another example, the interest level output device 3 transmits the obtained area interest level information to a display device near the user, to display the interest level information of the user on a display unit of the display device. As yet another example, the interest level output device 3 transmits the obtained area interest level information to a content server for selecting/creating recommendation information to the user. In such a case, the content server selects/creates recommendation information of high interest on a user basis according to the received area interest level information, and transmits the recommendation information to a terminal such as a mobile phone carried by the user.

In this exemplary embodiment, a storage device (not shown) of the information processing device for realizing the interest level measurement device 2 stores various programs for measuring the area interest level on a user basis. For example, the storage device of the information processing device for realizing the interest level measurement device 2 stores an interest level measurement program for causing a computer to execute: a process of acquiring area stay information that includes position information of an area in which a user stays and stay time information of a time during which the user stays in the area; a process of storing data acquired by a user terminal and indicating an action state of the user, and reading the stored data according to the acquired area stay information; a process of determining a behavior status of the user based on the read data, and creating a behavior status time-series pattern that indicates the behavior status of the user; a process of calculating a behavior feature value that indicates a feature of a behavior of the user, based on the created behavior status time-series pattern; and a process of determining an area interest level that indicates a degree and tendency of the user's interest in the area, using the calculated behavior feature value.

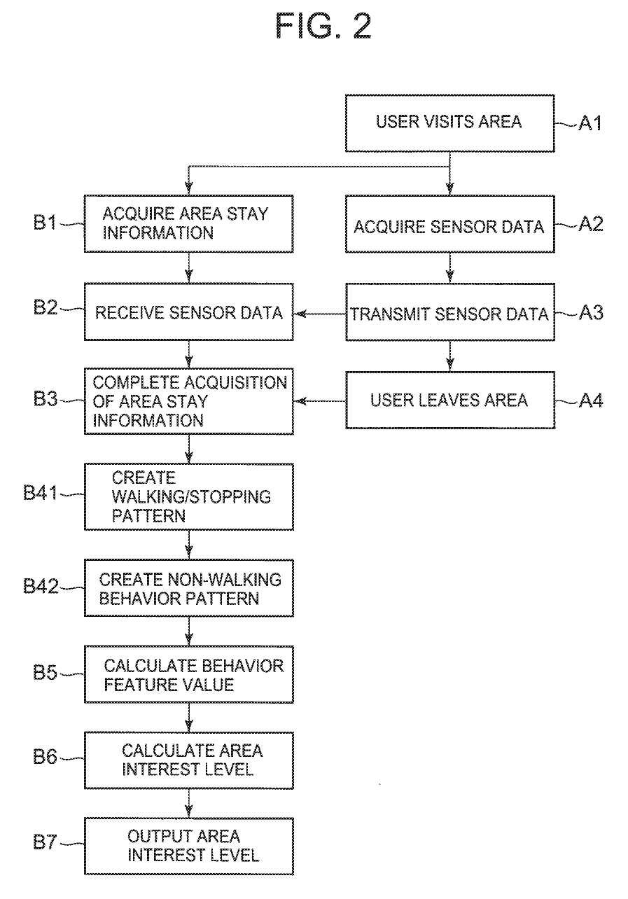

The following describes operations. FIG. 2 is a flowchart showing an example of a process of measuring an interest level in an area on a user basis in the interest level measurement system. When the user visits an area (step A1), the area stay information acquisition/notification unit 22 acquires area stay information (step B1). For example, suppose the sensor terminal 1 is a mobile phone equipped with an accelerometer, and the area stay information acquisition/notification unit 22 is realized by a GPS receiver equipped in the mobile phone. In this case, the area stay information acquisition/notification unit 22 acquires (obtains) information that the user enters a specific area, based on a GPS signal. Transmission/reception of sensor time-series data between the sensor terminal 1 and the interest level measurement device 2 is then launched.

The sensor terminal 1 acquires time-series data according to the user's walking/stopping behavior (step A2), and transmits the time-series data to the sensor data reception unit 21 (step A3). For example, in the case where the sensor is the accelerometer equipped in the mobile phone, the sensor terminal 1 transmits the acquired sensor time-series data at a regular time interval, using communication means of the mobile phone. The sensor data reception unit 21 in the interest level measurement device 2 receives the sensor time-series data from the sensor terminal 1 (step B2).

Subsequently, when the user leaves the area (step A4), the area stay information acquisition/notification unit 22 completes time information of the user's stay in the area, and outputs the notification information to the sensor data storage/reading unit 23 and the area interest level determination unit 26. The sensor data storage/reading unit 23 extracts, from the database device, sensor time-series data for the time period during which the user stays in the area, and supplies (outputs) the sensor time-series data to the walking/stopping pattern creation unit 24 and the non-walking behavior pattern creation unit 28 (step B3).

Next, the walking/stopping pattern creation unit 24 creates a walking/stopping time-series pattern based on the sensor time-series data received from the sensor data storage/reading unit 23, and supplies (outputs) the walking/stopping time-series pattern to the behavior feature value calculation unit 25 (step B41). For example, in the case where the sensor is the accelerometer, the walking/stopping pattern creation unit 24 calculates a value such as a variance of acceleration per second, and performs an operation such as comparing magnitudes of the calculated value such as the variance and a preset threshold, to determine whether the user is in a walking state or a stopping state. The walking/stopping pattern creation unit 24 arranges determination results in chronological order to create the walking/stopping time-series pattern.

The non-walking behavior pattern creation unit 28 creates a non-walking behavior time-series pattern based on the sensor time-series data received from the sensor data storage/reading unit 23, and supplies (outputs) the non-walking behavior time-series pattern to the behavior feature value calculation unit 25 (step B42). For example, in the case where the sensor included in the sensor terminal 1 is the accelerometer, the non-walking behavior pattern creation unit 28 determines whether or not the user is in a state of a non-walking behavior, based on a waveform of acceleration from the sensor terminal 1. The non-walking behavior pattern creation unit 28 arranges determination results in chronological order to create the non-walking behavior time-series pattern.

Though the example shown in FIG. 2 corresponds to the case where the process of creating the walking/stopping time-series pattern in step B41 is executed first and the process of creating the non-walking behavior time-series pattern in step B42 is executed next, the execution order of the processes is not limited to that described in this exemplary embodiment. For instance, the processes may be reversed so that the process of creating the non-walking behavior time-series pattern in step B42 is executed first and the process of creating the walking/stopping time-series pattern in step B41 is executed next. Alternatively, the process of creating the walking/stopping time-series pattern in step B41 and the process of creating the non-walking behavior time-series pattern in step B42 may be executed in parallel.

Next, the behavior feature value calculation unit 25 calculates a behavior feature value such as the walking time, the stopping time, and the non-walking behavior time within the time during which the user stays in the area or the total sums or mean values of such times, the ratio between the walking time, the stopping time, and the non-walking behavior time, the walking count, the stopping count, the non-walking behavior count, and the like, based on the walking/stopping time-series pattern received from the walking/stopping pattern creation unit 24 and the non-walking behavior time-series pattern received from the non-walking behavior pattern creation unit 28 (step B5). The behavior feature value calculation unit 25 supplies (outputs) the calculated behavior feature value to the area interest level determination unit 26.

Next, the area interest level determination unit 26 calculates an area interest level in the area on a user basis, using the behavior feature value received from the behavior feature value calculation unit 25 and the area stay information received from the area stay information acquisition/notification unit 22 (step B6). For instance, the area interest level determination unit 26 performs an operation such as comparing magnitudes of the received behavior feature value and a preset threshold, to determine the user's interest level in the area such as the user being interested in no product or the user being very interested in the area. Moreover, for example in the case where the non-walking behavior time as the behavior feature value is long, the area interest level determination unit 26 can determine that the user is in a state of changing his/her posture or squatting, and so can determine that the user is in a state of being interested in a product on a shelf or the like. The area interest level determination unit 26 supplies (outputs) the obtained area interest level information to the interest level output device 3.

Next, the interest level output device 3 performs control of outputting the area interest level information received from the area interest level determination unit 26 (step B7). As an example, the interest level output device 3 transmits the obtained area interest level information to a mobile phone possessed by the user, to display the area interest level information on a display unit of the mobile phone. As another example, the interest level output device 3 performs controls such as transmitting the obtained area interest level information to a content server for creating recommendation information to the user and the like.

As described above, according to this exemplary embodiment, the interest level measurement system obtains the walking/stopping time-series pattern indicating the walking state and the stopping state of the user using the sensor, and also obtains the non-walking behavior time-series pattern indicating whether or not the user is in a state of a non-walking behavior using the sensor. The interest level measurement system thereby determines the interest level on a user basis, based on the feature value indicating the degree and tendency of interest such as the walking time, the stopping time, and the non-walking behavior time within the time during which the user stays in the area or the total sums or mean values of such times, the ratio between the walking time, the stopping time, and the non-walking behavior time, the walking count, the stopping count, the non-walking behavior count, and the like. Thus, through the use of the behavior feature value calculated from the walking/stopping time-series pattern and the non-walking behavior time-series pattern of the user, the characteristics of the degree and tendency of interest that differ depending on the user, such as the purpose of visiting the store, the number of products the user is interested in, and the degree of interest, can be finely determined and recognized.

According to this exemplary embodiment, through the use of the behavior feature value calculated not only from the walking/stopping time-series pattern but also from the non-walking behavior time-series pattern, the interest level can be calculated by recognizing the detailed behavior status of the user that includes not only whether the user is in a walking state or a stopping state but also whether or not the user is in a state of a non-walking behavior. Hence, the interest level can be calculated more accurately. This allows, for example, the detail of the interest on a user basis (e.g. whether or not the user is in a state of seeing a product on a shelf while taking it in hand) to be finely determined.

Therefore, the detailed behavior status of the user can be recognized to calculate the fine interest level in each area by taking into account the degree and tendency of interest on a user basis.

### Exemplary Embodiment 2

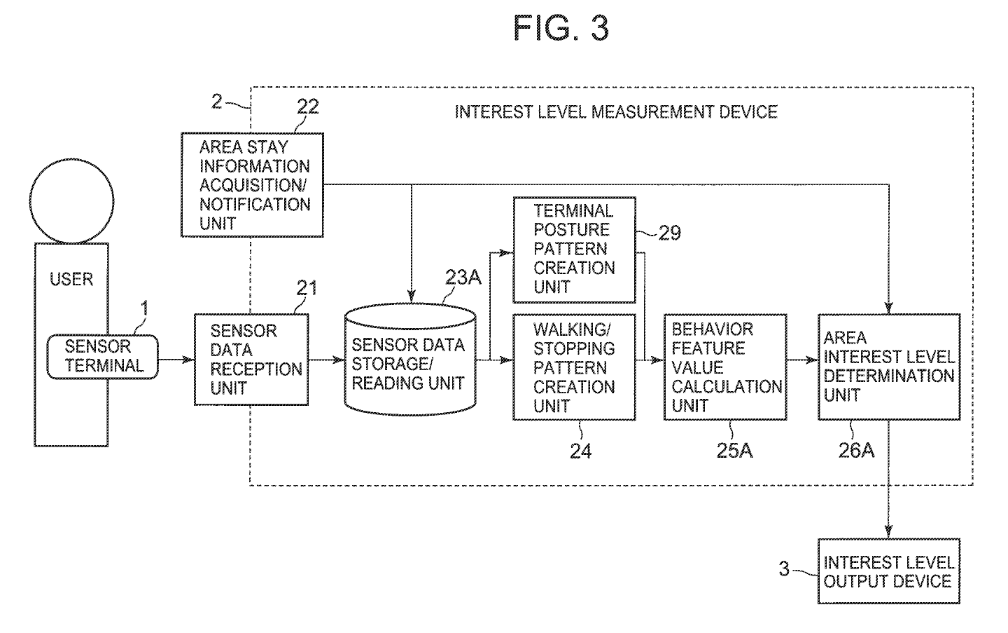

Exemplary Embodiment 2 of the present invention is described below, with reference to drawings. FIG. 3 is a block diagram showing an example of a structure of an interest level measurement system in Exemplary Embodiment 2. Exemplary Embodiment 2 differs from Exemplary Embodiment 1 in that the interest level measurement device 2 includes a terminal posture pattern creation unit 29 instead of the non-walking behavior pattern creation unit 28 shown in FIG. 1, as shown in FIG. 3. Besides, in Exemplary Embodiment 2, a sensor data storage/reading unit 23A, a behavior feature value calculation unit 25A, and an area interest level determination unit 26A have different functions from the sensor data storage/reading unit 23, the behavior feature value calculation unit 25, and the area interest level determination unit 26 in Exemplary Embodiment 1. The other components have the same functions as those in Exemplary Embodiment 1.

The sensor data storage/reading unit 23A has a function of continuously storing, in the database device, the sensor time-series data received from the sensor data reception unit 21, like the sensor data storage/reading unit 23 in Exemplary Embodiment 1. The sensor data storage/reading unit 23A also has a function of, upon reception of the notification information indicating the completion of the area stay time of the user from the area stay information acquisition/notification unit 22, reading the sensor time-series data stored in the database device and supplying (outputting) the read sensor time-series data to the walking/stopping pattern creation unit 24 and the terminal posture pattern creation unit 29, unlike the sensor data storage/reading unit 23 in Exemplary Embodiment 1.

The terminal posture pattern creation unit 29 is actually realized by the CPU of the information processing device operating according to the program. The terminal posture pattern creation unit 29 has a function of detecting a posture of the sensor terminal 1 (user terminal) possessed by the user, based on the sensor time-series data received from the sensor data storage/reading unit 23A. The terminal posture pattern creation unit 29 also has a function of supplying (outputting) a result of the detection to the behavior feature value calculation unit 25A as a terminal posture time-series pattern.

For example, in the case where the sensor included in the sensor terminal 1 is an accelerometer, the terminal posture pattern creation unit 29 detects the posture of the sensor terminal 1 by calculating the gravity vector indicating the posture of the sensor terminal 1 based on the acceleration from the sensor terminal 1. The terminal posture pattern creation unit 29 arranges detection results in chronological order to create the terminal posture time-series pattern.

The behavior feature value calculation unit 25A has a function of calculating a behavior feature value indicating a feature of a behavior of the user, based on the walking/stopping time-series pattern received from the walking/stopping pattern creation unit 24 and the terminal posture time-series pattern received from the terminal posture pattern creation unit 29. The behavior feature value calculation unit 25A also has a function of outputting the calculated behavior feature value to the area interest level determination unit 26A.

For instance, the behavior feature value calculation unit 25A calculates, as a behavior feature value, each of the feature values such as the walking time and the stopping time within the time during which the user stays in the area or the total sums or mean values of such times, the ratio between the walking time and the stopping time, the walking count, the stopping count, and the like. Moreover, for example, the behavior feature value calculation unit 25A defines the posture of the sensor terminal 1 in a predetermined state (e.g. a state in which the user is viewing the display screen of the sensor terminal 1) as a reference posture, and calculates, as a behavior feature value, a similarity S between the current posture of the sensor terminal 1 indicated by the received terminal posture time-series pattern and the reference posture. In detail, the behavior feature value calculation unit 25A calculates a similarity between each current posture of the sensor terminal 1 indicated by the terminal posture time-series pattern and the reference posture, and calculates a mean value of the similarities as a behavior feature value. The behavior feature value calculation unit 25A also calculates the variance of the gravity vector as a behavior feature value, based on the received terminal posture time-series pattern. The behavior feature value calculation unit 25A then supplies (outputs) the calculated behavior feature value to the area interest level determination unit 26A.

The area interest level determination unit 26A has a function of determining an area interest level indicating the degree of interest in the area on a user basis, using the behavior feature value received from the behavior feature value calculation unit 25A and the area stay information received from the area stay information acquisition/notification unit 22. The area interest level determination unit 26A also has a function of outputting area interest level information indicating the determined area interest level to the interest level output device 3.

For instance, like in Exemplary Embodiment 1, the area interest level determination unit 26A performs an operation such as comparing magnitudes of the behavior feature value received from the behavior feature value calculation unit 25A and a preset threshold. For a user whose stay time in the area is long but whose stopping time is short, the area interest level determination unit 26A determines that the user has a low degree of interest in the area. For a user whose stay time in the area is short but whose stopping time ratio is high, the area interest level determination unit 26A determines that the user is very interested in the area.

Moreover, unlike in Exemplary Embodiment 1, for example in the case where the similarity S as the behavior feature value is high, the area interest level determination unit 26A can determine that the user is in a state of viewing the display screen of the sensor terminal 1 while using an application and the like, and so is in a state of not being interested in a product on a shelf or the like. Furthermore, for example in the case where the gravity vector variance as the behavior feature value is high, the area interest level determination unit 26A can determine that the user is in a state of seeing a product while substantially changing his/her posture. Through such determination, the area interest level determination unit 26A determines the user's area interest level in the area, and supplies (outputs) the determination result of the area interest level (area interest level information) to the interest level output device 3.

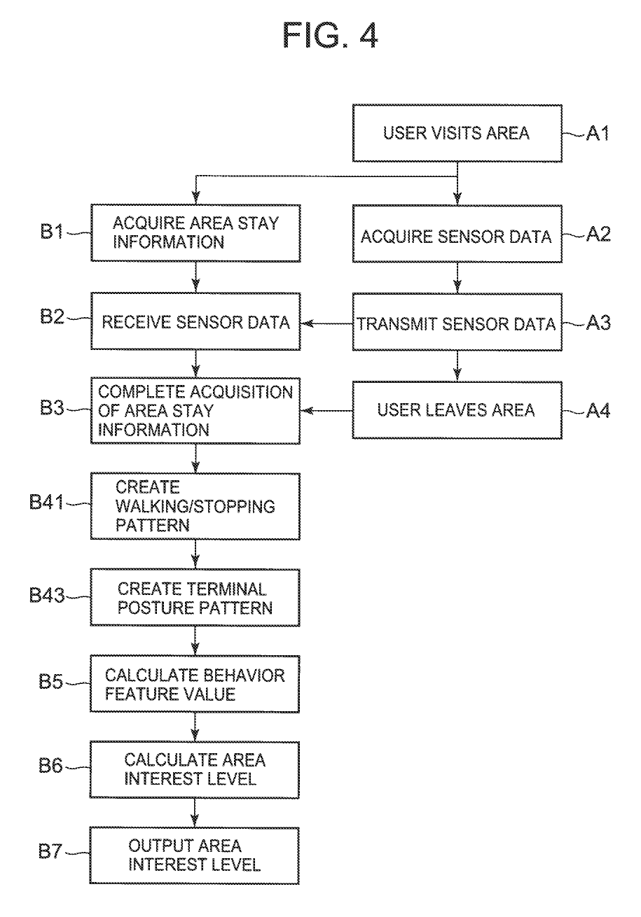

The following describes operations. FIG. 4 is a flowchart showing an example of a process of measuring an interest level in an area on a user basis in the interest level measurement system in Exemplary Embodiment 2. In this exemplary embodiment, the processes of steps A1 to A4 and steps B1 and B2 are respectively the same as those in Exemplary Embodiment 1.

When the user leaves the area in step A4, the area stay information acquisition/notification unit 22 completes time information of the user's stay in the area, and outputs the notification information to the sensor data storage/reading unit 23A and the area interest level determination unit 26A. The sensor data storage/reading unit 23A extracts, from the database device, sensor time-series data for the time period during which the user stays in the area, and supplies (outputs) the sensor time-series data to the walking/stopping pattern creation unit 24 and the terminal posture pattern creation unit 29 (step B3).

Next, the walking/stopping pattern creation unit 24 creates a walking/stopping time-series pattern based on the sensor time-series data received from the sensor data storage/reading unit 23A, and supplies (outputs) the walking/stopping time-series pattern to the behavior feature value calculation unit 25A (step B41). For example, in the case where the sensor is the accelerometer, the walking/stopping pattern creation unit 24 calculates a value such as a variance of acceleration per second, and performs an operation such as comparing magnitudes of the calculated value such as the variance and a preset threshold, to determine whether the user is in a walking state or a stopping state. The walking/stopping pattern creation unit 24 arranges determination results in chronological order to create the walking/stopping time-series pattern.

The terminal posture pattern creation unit 29 creates a terminal posture time-series pattern based on the sensor time-series data received from the sensor data storage/reading unit 23A, and supplies (outputs) the terminal posture time-series pattern to the behavior feature value calculation unit 25A (step B43). For example, in the case where the sensor included in the sensor terminal 1 is the accelerometer, the terminal posture pattern creation unit 29 calculates a gravity vector indicating the posture of the sensor terminal 1 based on the acceleration from the sensor terminal 1, thereby detecting the posture of the sensor terminal 1. The terminal posture pattern creation unit 29 arranges detection results in chronological order to create the terminal posture time-series pattern.

Though the example shown in FIG. 4 corresponds to the case where the process of creating the walking/stopping time-series pattern in step B41 is executed first and the process of creating the terminal posture time-series pattern in step B43 is executed next, the execution order of the processes is not limited to that described in this exemplary embodiment. For instance, the processes may be reversed so that the process of creating the terminal posture time-series pattern in step B43 is executed first and the process of creating the walking/stopping time-series pattern in step B41 is executed next. Alternatively, the process of creating the walking/stopping time-series pattern in step B41 and the process of creating the terminal posture time-series pattern in step B43 may be executed in parallel.

Next, the behavior feature value calculation unit 25A calculates a behavior feature value such as the walking time and the stopping time within the time during which the user stays in the area or the total sums or mean values of such times, the ratio between the walking time and the stopping time, the walking count, the stopping count, and the like, based on the walking/stopping time-series pattern received from the walking/stopping pattern creation unit 24 and the terminal posture time-series pattern received from the terminal posture pattern creation unit 29 (step B5). The behavior feature value calculation unit 25A also calculates, for example, the similarity S and the gravity vector variance as a behavior feature value. The behavior feature value calculation unit 25A supplies (outputs) the calculated behavior feature value to the area interest level determination unit 26A.

Next, the area interest level determination unit 26A calculates an area interest level in the area on a user basis, using the behavior feature value received from the behavior feature value calculation unit 25A and the area stay information received from the area stay information acquisition/notification unit 22 (step B6). For example, the area interest level determination unit 26A performs an operation such as comparing magnitudes of the received behavior feature value and a preset threshold, to determine the user's interest level in the area such as the user being interested in no product or the user being very interested in the area. Moreover, for example in the case where the similarity S as the behavior feature value is high, the area interest level determination unit 26A can determine that the user is in a state of viewing the display screen of the sensor terminal 1 while using an application and the like, and so is in a state of not being interested in a product on a shelf or the like. Furthermore, for example in the case where the gravity vector variance as the behavior feature value is high, the area interest level determination unit 26A can determine that the user is in a state of seeing a product while substantially changing his/her posture. The area interest level determination unit 26A supplies (outputs) the obtained area interest level information to the interest level output device 3.

In this exemplary embodiment, the process of step B7 is the same as that in Exemplary Embodiment 1.

As described above, according to this exemplary embodiment, the interest level measurement system obtains the walking/stopping time-series pattern indicating the walking state and the stopping state of the user using the sensor, and also obtains the non-walking behavior time-series pattern indicating whether or not the user is in a state of a non-walking behavior using the sensor. The interest level measurement system thereby determines the interest level on a user basis, based on the feature value indicating the degree and tendency of interest such as the walking time and the stopping time within the time during which the user stays in the area or the total sums or mean values of such times, the ratio between the walking time and the stopping time, the walking count, the stopping count, the similarity S, the gravity vector variance, and the like. Thus, through the use of the behavior feature value calculated from the walking/stopping time-series pattern and the terminal posture time-series pattern of the user, the characteristics of the degree and tendency of interest that differ depending on the user, such as the purpose of visiting the store, the number of products the user is interested in, and the degree of interest, can be finely determined and recognized.

According to this exemplary embodiment, through the use of the behavior feature value calculated not only from the walking/stopping time-series pattern but also from the terminal posture time-series pattern, the interest level can be calculated by not only recognizing whether the user is in a walking state or a stopping state but also indirectly recognizing the behavior status of the user (e.g. a state in which the user is viewing the display screen of the sensor terminal 1 or a state in which the user is substantially changing his/her posture) from the posture of the sensor terminal 1. Hence, the interest level can be calculated more accurately. This allows, for example, the detail of the interest on a user basis (e.g. whether or not the user is in a state of being interested in using an application on the sensor terminal 1 and whether or not the user is paying attention to a product) to be finely determined.

Therefore, the detailed behavior status of the user can be recognized to calculate the fine interest level in each area by taking into account the degree and tendency of interest on a user basis.

In this exemplary embodiment, the interest level measurement device 2 may further include the non-walking behavior pattern creation unit 28 in Exemplary Embodiment 1. According to such a structure, the interest level can be calculated from the behavior feature value obtained using both the non-walking behavior time-series pattern and the terminal posture time-series pattern in addition to the walking/stopping time-series pattern. Hence, the interest level can be calculated more accurately.

### Exemplary Embodiment 3

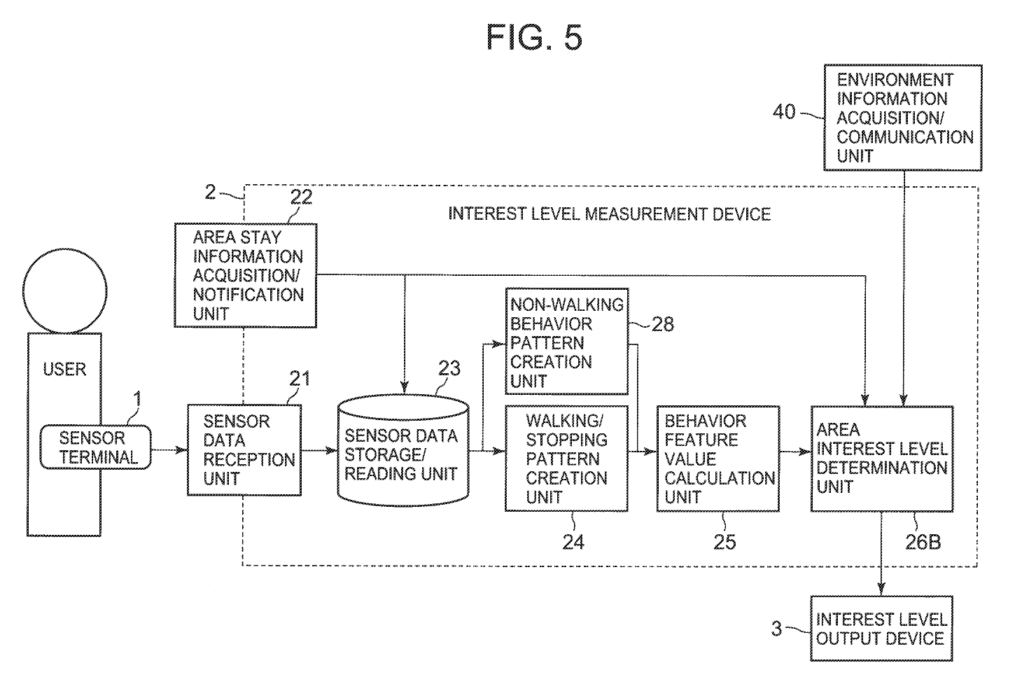

Exemplary Embodiment 3 of the present invention is described below, with reference to drawings. FIG. 5 is a block diagram showing an example of a structure of an interest level measurement system in Exemplary Embodiment 3. Exemplary Embodiment 3 differs from Exemplary Embodiment 1 in that the interest level measurement system includes an environment information acquisition/communication unit 40 in addition to the components shown in FIG. 1. Besides, in Exemplary Embodiment 3, an area interest level determination unit 26B has a different function from the area interest level determination unit 26 in Exemplary Embodiment 1. The other components have the same functions as those in Exemplary Embodiment 1.

The environment information acquisition/communication unit 40 is actually realized by a pyroelectric sensor or a camera, a temperature sensor, a humidity sensor, and an information processing device such as a personal computer operating according to a program. The environment information acquisition/communication unit 40 has a function of acquiring environment information indicating a status of an area in which the user stays, based on inputs from various sensors such as the pyroelectric sensor or the camera, the temperature sensor, and the humidity sensor positioned in the area. The environment information acquisition/communication unit 40 also has a function of transmitting the obtained environment information to the interest level measurement device 2 via a network.

For example, the environment information acquisition/communication unit 40 receives a detection signal from the pyroelectric sensor positioned in the area, to obtain the number of people in the area as environment information. As an alternative, the environment information acquisition/communication unit 40 may analyze an image captured by the camera to obtain the number of people in the area as environment information in the case where the camera is positioned in the area. Moreover, for example, the environment information acquisition/communication unit 40 receives a detection signal from the temperature sensor positioned in the area, to obtain a temperature in the area as environment information. Furthermore, for example, the environment information acquisition/communication unit 40 receives a detection signal from the humidity sensor positioned in the area, to obtain a humidity in the area as environment information.

The area interest level determination unit 26B has a function of determining an area interest level indicating the degree of interest in the area on a user basis, using the behavior feature value received from the behavior feature value calculation unit 25, the area stay information received from the area stay information acquisition/notification unit 22, and the environment information received from the environment information acquisition/communication unit 40. The area interest level determination unit 26B also has a function of outputting area interest level information indicating the determined area interest level to the interest level output device 3.

For instance, like in Exemplary Embodiment 1, the area interest level determination unit 26B performs an operation such as comparing magnitudes of the behavior feature value received from the behavior feature value calculation unit 25 and a preset threshold. For a user whose stay time in the area is long but whose stopping time is short, the area interest level determination unit 26B determines that the user has a low degree of interest in the area. For a user whose stay time in the area is short but whose stopping time ratio is high, the area interest level determination unit 26B determines that the user is very interested in the area.

Moreover, unlike in Exemplary Embodiment 1, for example in the case where the number of people in the area indicated by the environment information is large (e.g. not less than a predetermined number), the area interest level determination unit 26B can determine that the user is interested in a highly populated place. Furthermore, for example in the case where the temperature in the area indicated by the environment information is high (e.g. not less than a predetermined temperature), the area interest level determination unit 26B can determine that the user stays in the area even though the area is high in temperature, and so can determine that the user is very interested in the area. Through such determination, the area interest level determination unit 26B determines the user's area interest level in the area, and supplies (outputs) the determination result of the area interest level (area interest level information) to the interest level output device 3.

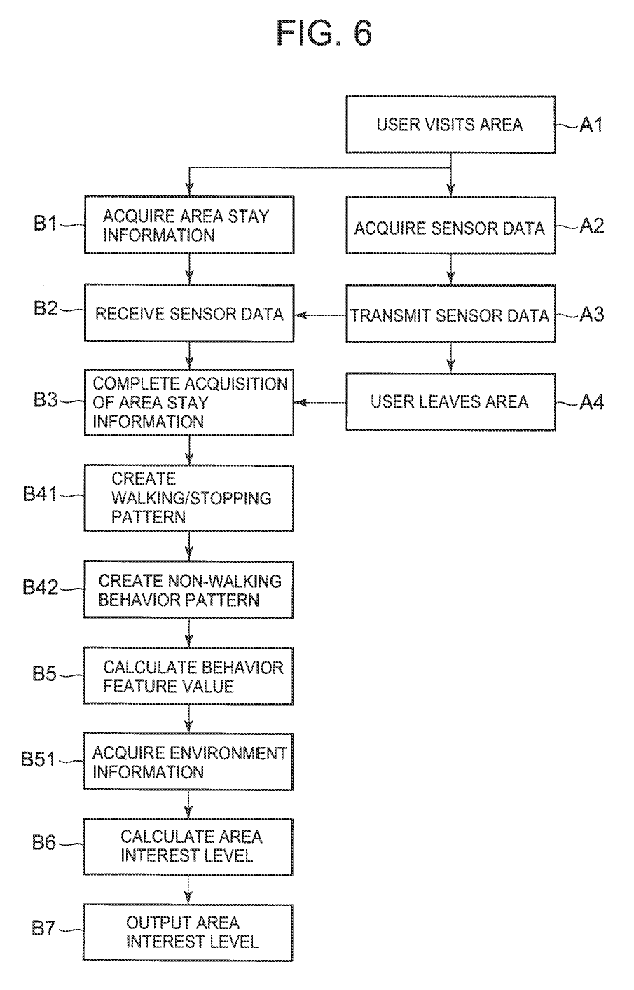

The following describes operations. FIG. 6 is a flowchart showing an example of a process of measuring an interest level in an area on a user basis in the interest level measurement system in Exemplary Embodiment 3. In this exemplary embodiment, the processes of steps A1 to A4 and steps B1 to B5 are respectively the same as those in Exemplary Embodiment 1.

In step B51, the area interest level determination unit 26B acquires environment information obtained by the environment information acquisition/communication unit 40. For instance, the area interest level determination unit 26B receives the environment information from the environment information acquisition/communication unit 40 via a network. Note that the timing of receiving the environment information from the environment information acquisition/communication unit 40 is not limited to that described in this exemplary embodiment. For example, the area interest level determination unit 26B may receive environment information from the environment information acquisition/communication unit 40 at any time and store the received environment information in a storage unit regardless of the timing of area interest level calculation, and extract latest environment information stored in the storage unit in step B51.

The area interest level determination unit 26B determines an area interest level in the area on a user basis, using the behavior feature value received from the behavior feature value calculation unit 25, the area stay information received from the area stay information acquisition/notification unit 22, and the environment information received from the environment information acquisition/communication unit 40 (step B6). For example, the area interest level determination unit 26B performs an operation such as comparing magnitudes of the received behavior feature value and a preset threshold, to determine the user's interest level in the area such as the user being interested in no product or the user being very interested in the area. Moreover, for example in the case where the number of people in the area indicated by the environment information is large (e.g. not less than a predetermined number), the area interest level determination unit 26B can determine that the user is interested in a highly populated place. Furthermore, for example in the case where the temperature in the area indicated by the environment information is high (e.g. not less than a predetermined temperature), the area interest level determination unit 26B can determine that the user stays in the area even though the area is high in temperature, and so can determine that the user is very interested in the area. The area interest level determination unit 26B supplies (outputs) the obtained area interest level information to the interest level output device 3.

In this exemplary embodiment, the process of step B7 is the same as that in Exemplary Embodiment 1.

As described above, according to this exemplary embodiment, the interest level measurement system determines the user's interest level based on not only the behavior feature value but also the environment information indicating the status in the area. Thus, in addition to the advantageous effects of Exemplary Embodiment 1, the characteristics of the degree and tendency of interest that differ depending on the user can be finely determined and recognized by recognizing the area status such as the number of people, the temperature, and the humidity in the area.

Though this exemplary embodiment describes the case where the interest level measurement system in Exemplary Embodiment 1 further includes the environment information acquisition/communication unit 40, the interest level measurement system in Exemplary Embodiment 2 may further include the environment information acquisition/communication unit 40. As an alternative, an interest level measurement system that includes both of the non-walking behavior pattern creation unit 28 in Exemplary Embodiment 1 and the terminal posture pattern creation unit 29 in Exemplary Embodiment 2 may further include the environment information acquisition/communication unit 40.

### Exemplary Embodiment 4

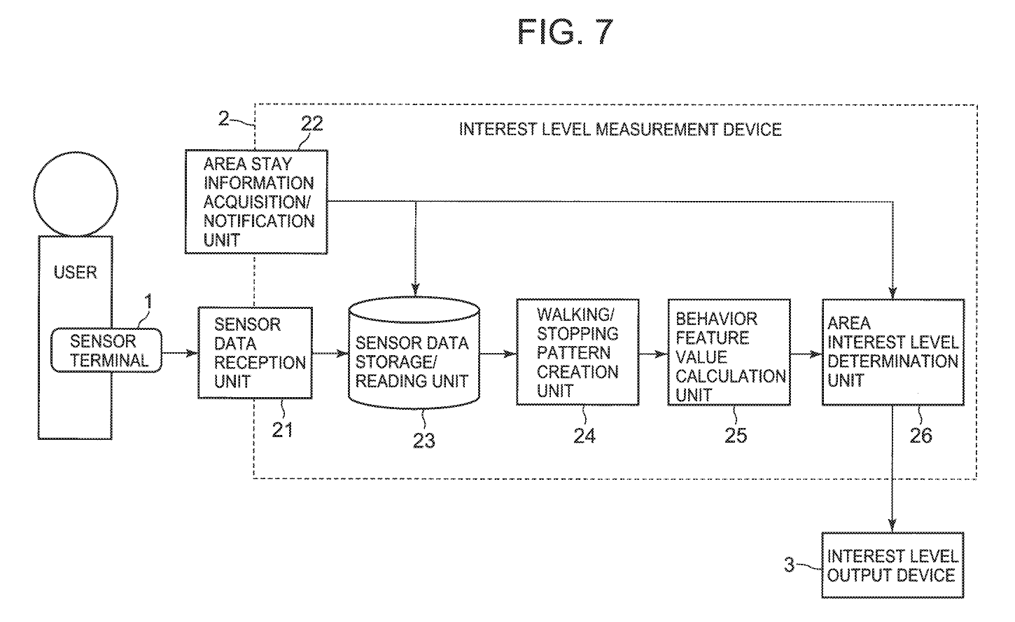

Exemplary Embodiment 4 of the present invention is described below, with reference to drawings. FIG. 7 is a block diagram showing an example of a structure of an interest level measurement system in Exemplary Embodiment 4. As shown in FIG. 7, the interest level measurement system in this exemplary embodiment includes the sensor terminal 1, the interest level measurement device 2, and the interest level output device 3.

The sensor terminal 1 includes a sensor for acquiring information relating to human walking/stopping actions. The sensor terminal 1 has a function of transmitting sensor time-series data acquired using the sensor, to the interest level measurement device 2. As an example, the sensor terminal 1 is realized by a mobile terminal such as a mobile phone equipped with an accelerometer. In this case, the sensor terminal 1 transmits time-series data (hereafter also referred to as sensor time-series data) of acceleration detected by the accelerometer to the interest level measurement device 2 via a communication network including a mobile phone network, as information relating to walking/stopping actions of a user who carries the sensor terminal 1 (mobile phone).

The interest level measurement device 2 is, for instance, a device operated by a communication carrier or a service provider providing interest level measurement service. As an example, the interest level measurement device 2 is realized using an information processing device such as a personal computer operating according to a program. The interest level measurement system including the interest level measurement device 2 may be realized using one mobile terminal (interest level measurement terminal) such as a mobile phone.

As shown in FIG. 7, the interest level measurement device 2 includes the sensor data reception unit 21, the area stay information acquisition/notification unit 22, the sensor data storage/reading unit 23, the walking/stopping pattern creation unit 24, the behavior feature value calculation unit 25, and the area interest level determination unit 26.

The sensor data reception unit 21 has a function of receiving the sensor time-series data acquired by the sensor terminal 1, from the sensor terminal 1 via the communication network. The sensor data reception unit 21 also has a function of supplying (outputting) the received sensor time-series data to the sensor data storage/reading unit 23. As an example, in the case where the sensor terminal 1 is realized by a mobile phone, the sensor data reception unit 21 is realized by a base station of the mobile phone, a wireless LAN access point, or the like.

The area stay information acquisition/notification unit 22 has a function of acquiring area stay information that includes a position of an area in which the user stays and a time during which the user stays in the area. The area stay information acquisition/notification unit 22 also has a function of transmitting or outputting the acquired area stay information to the interest level measurement device 2.

For example, in the case where the sensor terminal 1 is a mobile phone, the area stay information acquisition/notification unit 22 uses the following area stay information acquisition method. The area stay information acquisition/notification unit 22 calculates, as a stay time, a time from when the user enters an area of a fixed range to when the user leaves the area, using positioning information received by a GPS receiver equipped in the mobile phone. The area stay information acquisition/notification unit 22 then transmits the calculated area stay information to the interest level measurement device 2 via the communication network. In this case, the area stay information acquisition/notification unit 22 is realized by the GPS receiver, a network interface unit, and a CPU of the mobile phone operating according to a program.

Alternatively, for example, the area stay information acquisition/notification unit 22 stores installation positions of a plurality of sensor data reception units 21 (base stations or access points) installed at various places, in a database beforehand. The area stay information acquisition/notification unit 22 determines position information of a sensor data reception unit 21 used for data reception of sensor time-series data, as the area in which the user stays. The area stay information acquisition/notification unit 22 also calculates a time during which the same sensor data reception unit 21 continuously receives data, as the stay time. The area stay information acquisition/notification unit 22 outputs the calculated area stay information to the interest level measurement device 2. In this case, the area stay information acquisition/notification unit 22 is realized by a network interface unit and a CPU of the information processing device for realizing the interest level measurement device 2.

The area stay information acquisition/notification unit 22 may instead notify (transmit) area stay information explicitly indicating the user's visit to the stay area to the interest level measurement device 2, according to an operation by the user. In this case, the area stay information acquisition/notification unit 22 is realized by the network interface unit and the CPU of the mobile phone operating according to the program.

The area stay information acquisition/notification unit 22 also has a function of notifying (outputting) notification information for instructing the sensor data storage/reading unit 23 to supply (output) the sensor time-series data to the walking/stopping pattern creation unit 24, upon completion of the area stay time of the user. The area stay information acquisition/notification unit 22 further has a function of simultaneously supplying (outputting) the area stay information to the area interest level determination unit 26.

The sensor data storage/reading unit 23 is actually realized by the CPU of the information processing device operating according to the program and a database device such as a magnetic disk device or an optical disc device. The sensor data storage/reading unit 23 has a function of continuously storing the sensor time-series data received from the sensor data reception unit 21, in the database device. The sensor data storage/reading unit 23 also has a function of, upon reception of the notification information indicating the completion of the area stay time of the user from the area stay information acquisition/notification unit 22, reading the sensor time-series data stored in the database device and supplying (outputting) the read sensor time-series data to the walking/stopping pattern creation unit 24.

The walking/stopping pattern creation unit 24 is actually realized by the CPU of the information processing device operating according to the program. The walking/stopping pattern creation unit 24 has a function of determining whether the user is in a walking state or a stopping state, based on the sensor time-series data received from the sensor data storage/reading unit 23. The walking/stopping pattern creation unit 24 also has a function of supplying (outputting) a result of the determination to the behavior feature value calculation unit 25 as a walking/stopping time-series pattern.

For instance, in the case where the sensor included in the sensor terminal 1 is an accelerometer, the walking/stopping pattern creation unit 24 calculates a value such as a variance of acceleration per second. The walking/stopping pattern creation unit 24 performs an operation such as comparing magnitudes of the calculated value such as the variance and a preset threshold, to determine whether the user is in a walking state or a stopping state. The walking/stopping pattern creation unit 24 arranges determination results in chronological order to create the walking/stopping time-series pattern.

The behavior feature value calculation unit 25 is actually realized by the CPU of the information processing device operating according to the program. The behavior feature value calculation unit 25 has a function of calculating a behavior feature value indicating a feature of a behavior of the user, based on the walking/stopping time-series pattern received from the walking/stopping pattern creation unit 24. The behavior feature value calculation unit 25 also has a function of outputting the calculated behavior feature value to the area interest level determination unit 26.

For instance, the behavior feature value calculation unit 25 calculates, as a behavior feature value, each of the feature values such as the total sum or mean value of the stopping time within the time during which the user stays in the area, the ratio between the walking time and the stopping time, the stopping count, and the like. The behavior feature value calculation unit 25 supplies (outputs) the calculated behavior feature value to the area interest level determination unit 26.

The area interest level determination unit 26 is actually realized by the CPU of the information processing device operating according to the program. The area interest level determination unit 26 has a function of determining an area interest level indicating the degree of interest in the area on a user basis, using the behavior feature value received from the behavior feature value calculation unit 25 and the area stay information received from the area stay information acquisition/notification unit 22. The area interest level determination unit 26 also has a function of outputting area interest level information indicating the determined area interest level to the interest level output device 3.

For instance, the area interest level determination unit 26 performs an operation such as comparing magnitudes of the behavior feature value received from the behavior feature value calculation unit 25 and a preset threshold. For a user whose stay time in the area is long but whose stopping time is short, the area interest level determination unit 26 determines that the user has a low degree of interest in the area. For a user whose stay time in the area is short but whose stopping time ratio is high, the area interest level determination unit 26 determines that the user is very interested in the area. Through such determination, the area interest level determination unit 26 determines the user's area interest level in the area, and supplies (outputs) the determination result of the area interest level (area interest level information) to the interest level output device 3.

The interest level output device 3 may actually be realized by the network interface unit and the CPU of the information processing device operating according to the program. The interest level output device 3 is a device for outputting, in a usable form, the area interest level information on a user basis received from the area interest level determination unit 26.

As an example, the interest level output device 3 transmits the obtained area interest level information to a mobile phone possessed by the user, to display the interest level information of the user on a display unit of the mobile phone. As another example, the interest level output device 3 transmits the obtained area interest level information to a content server for selecting/creating recommendation information to the user. In such a case, the content server selects/creates recommendation information of high interest on a user basis according to the received area interest level information, and transmits the recommendation information to a terminal such as a mobile phone carried by the user.

In this exemplary embodiment, a storage device (not shown) of the information processing device for realizing the interest level measurement device 2 stores various programs for measuring the area interest level on a user basis. For example, the storage device of the information processing device for realizing the interest level measurement device 2 stores an interest level measurement program for causing a computer to execute: a process of acquiring data that indicates an action state of a user, using a sensor; a process of acquiring area stay information that includes position information of an area in which the user stays and stay time information of a time during which the user stays in the area; a process of storing the acquired data, and reading the stored data according to the acquired area stay information; a process of determining whether the user is in a walking state or a stopping state based on the read data, and creating a walking/stopping time-series pattern that indicates whether the user is in the walking state or the stopping state; a process of calculating a behavior feature value that indicates a feature of a behavior of the user, based on the created walking/stopping time-series pattern; and a process of determining an area interest level that indicates a degree and tendency of the user's interest in the area, using the calculated behavior feature value.

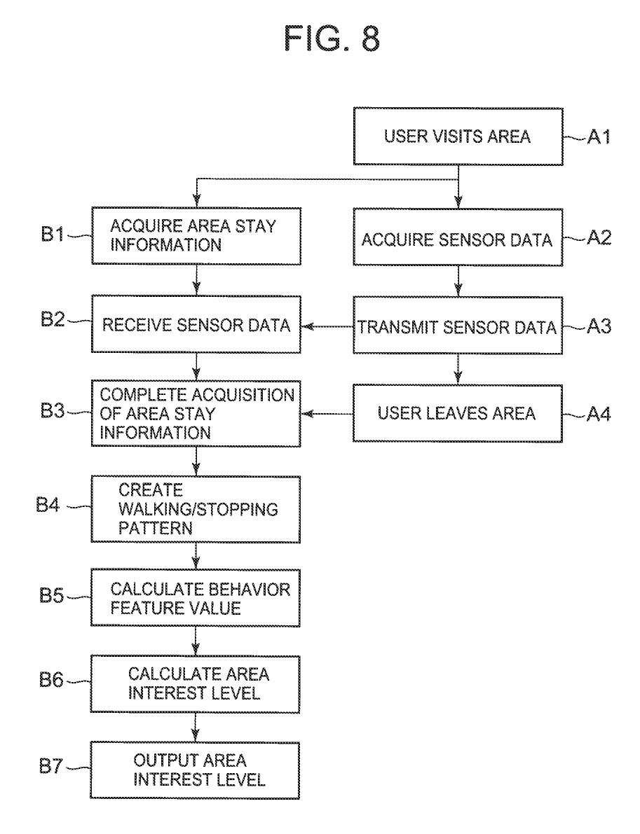

The following describes operations. FIG. 8 is a flowchart showing an example of a process of measuring an interest level in an area on a user basis in the interest level measurement system in Exemplary Embodiment 4. When the user visits an area (step A1), the area stay information acquisition/notification unit 22 acquires area stay information (step B1). For example, suppose the sensor terminal 1 is a mobile phone equipped with an accelerometer, and the area stay information acquisition/notification unit 22 is realized by a GPS receiver equipped in the mobile phone. In this case, the area stay information acquisition/notification unit 22 acquires (obtains) information that the user enters a specific area, based on a GPS signal. Transmission/reception of sensor time-series data between the sensor terminal 1 and the interest level measurement device 2 is then launched.

The sensor terminal 1 acquires time-series data according to the user's walking/stopping behavior (step A2), and transmits the time-series data to the sensor data reception unit 21 (step A3). For example, in the case where the sensor is the accelerometer equipped in the mobile phone, the sensor terminal 1 transmits the acquired sensor time-series data at a regular time interval, using communication means of the mobile phone. The sensor data reception unit 21 in the interest level measurement device 2 receives the sensor time-series data from the sensor terminal 1 (step B2).

Subsequently, when the user leaves the area (step A4), the area stay information acquisition/notification unit 22 completes time information of the user's stay in the area, and outputs the notification information to the sensor data storage/reading unit 23 and the area interest level determination unit 26. The sensor data storage/reading unit 23 extracts, from the database device, sensor time-series data for the time period during which the user stays in the area, and supplies (outputs) the sensor time-series data to the walking/stopping pattern creation unit 24 (step B3).

Next, the walking/stopping pattern creation unit 24 creates a walking/stopping time-series pattern based on the sensor time-series data received from the sensor data storage/reading unit 23, and supplies (outputs) the walking/stopping time-series pattern to the behavior feature value calculation unit 25 (step B4). For example, in the case where the sensor is the accelerometer, the walking/stopping pattern creation unit 24 calculates a value such as a variance of acceleration per second, and performs an operation such as comparing magnitudes of the calculated value such as the variance and a preset threshold, to determine whether the user is in a walking state or a stopping state. The walking/stopping pattern creation unit 24 arranges determination results in chronological order to create the walking/stopping time-series pattern.

Next, the behavior feature value calculation unit 25 calculates a behavior feature value such as the total sum or mean value of the stopping time within the time during which the user stays in the area, the ratio between the walking time and the stopping time, and the like, based on the walking/stopping time-series pattern received from the walking/stopping pattern creation unit 24 (step B5). The behavior feature value calculation unit 25 supplies (outputs) the calculated behavior feature value to the area interest level determination unit 26.

Next, the area interest level determination unit 26 calculates an area interest level in the area on a user basis, using the behavior feature value received from the behavior feature value calculation unit 25 and the area stay information received from the area stay information acquisition/notification unit 22 (step B6). For example, the area interest level determination unit 26 performs an operation such as comparing magnitudes of the received behavior feature value and a preset threshold, to determine the user's interest level in the area such as the user being interested in no product or the user being very interested in the area. The area interest level determination unit 26 supplies (outputs) the obtained area interest level information to the interest level output device 3.

Next, the interest level output device 3 performs control of outputting the area interest level information received from the area interest level determination unit 26 (step B7). As an example, the interest level output device 3 transmits the obtained area interest level information to a mobile phone possessed by the user, to display the area interest level information on a display unit of the mobile phone. As another example, the interest level output device 3 performs controls such as transmitting the obtained area interest level information to a content server for creating recommendation information to the user and the like.

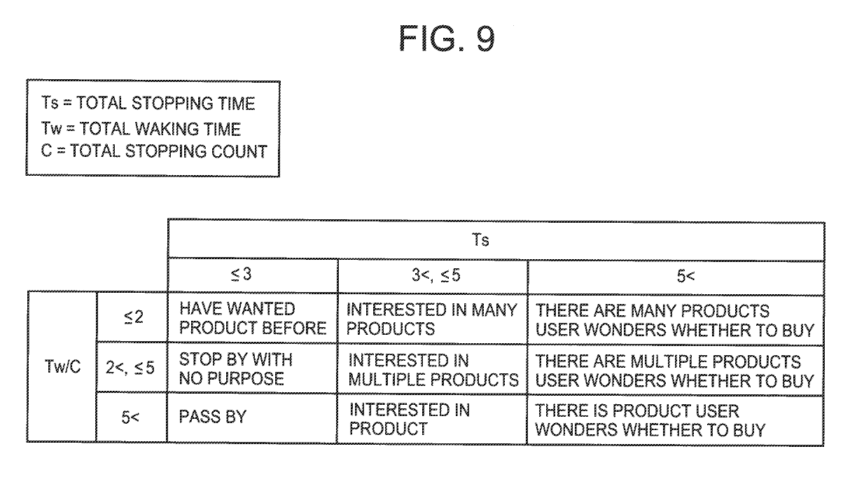

As described above, according to this exemplary embodiment, the interest level measurement system obtains the time-series pattern indicating the walking state and the stopping state of the user using the sensor. The interest level measurement system thereby determines the interest level on a user basis, based on the feature value indicating the degree and tendency of interest such as the total sum or mean value of the stopping time, the ratio between the walking time and the stopping time, the stopping count, and the like. Thus, through the use of the behavior feature value calculated from the walking/stopping time-series pattern of the user, the characteristics of the degree and tendency of interest that differ depending on the user, such as the purpose of visiting the store, the number of products the user is interested in, and the degree of interest, can be finely determined and recognized. For instance, as shown in FIG. 9 as an example, based on a relationship between behavior feature values and user interest levels obtained from a result of an experiment conducted beforehand, the characteristics of the degree and tendency of interest that differ depending on the user can be finely determined and recognized according to the purpose of visiting the store, the number of products the user is interested in, and the degree of interest. This enables calculation of the fine interest level in each area by taking into account the degree and tendency of interest on a user basis.

In this exemplary embodiment, for example, the walking/stopping pattern creation unit 24 may also determine the state of the non-walking behavior of the user by the same method as in Exemplary Embodiment 1, and create the walking/stopping time-series pattern from which a section determined as the non-walking behavior is excluded. Simply determining whether the user is in a walking state or a stopping state can incur a possibility that the state of the user squatting or stretching is wrongly determined as a walking state, causing a decrease in accuracy of the walking/stopping time-series pattern. In view of this, by also determining the state of the non-walking behavior of the user and excluding such a state from the walking/stopping time-series data, the accuracy of the walking/stopping time-series data can be enhanced, which contributes to higher determination accuracy of the user's interest level.

### Exemplary Embodiment 5

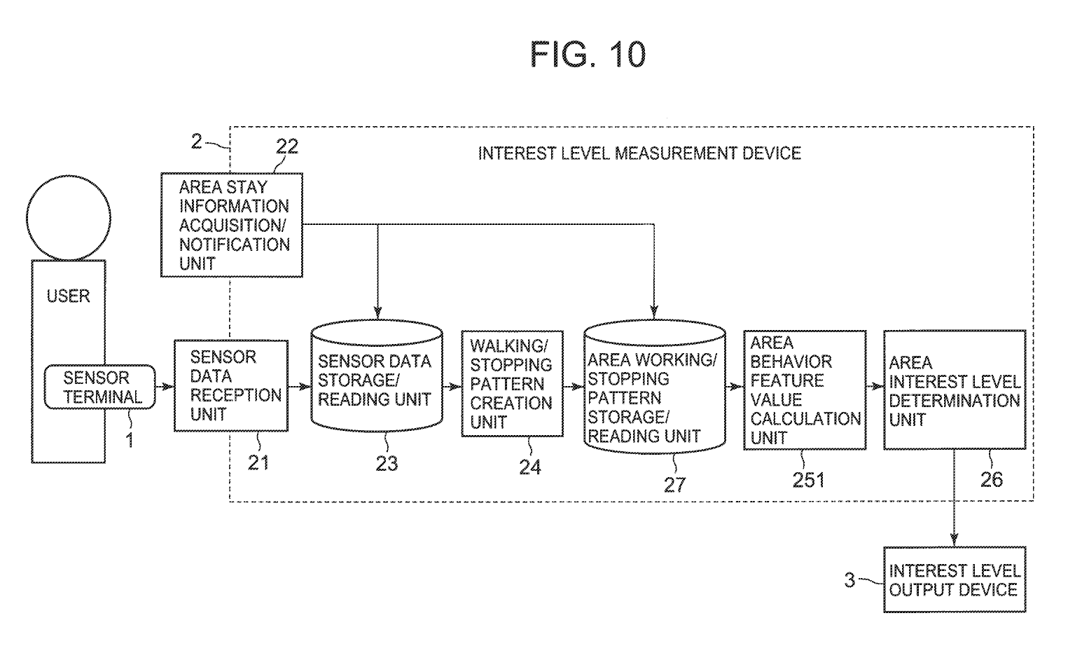

Exemplary Embodiment 5 of the present invention is described below, with reference to drawings. FIG. 10 is a block diagram showing an example of a structure of an interest level measurement system in Exemplary Embodiment 5. Exemplary Embodiment 5 differs from Exemplary Embodiment 4 in that the interest level measurement system includes an area walking/stopping pattern storage/reading unit 27 in addition to the components shown in FIG. 7, as shown in FIG. 10. Exemplary Embodiment 5 also differs from Exemplary Embodiment 4 in that the interest level measurement system includes an area behavior feature value calculation unit 251 instead of the behavior feature value calculation unit 25 shown in FIG. 7.

The area walking/stopping pattern storage/reading unit 27 is actually realized by the CPU of the information processing device operating according to the program and a database device such as a magnetic disk device or an optical disc device. The area walking/stopping pattern storage/reading unit 27 stores the walking/stopping time-series pattern received from the walking/stopping pattern creation unit 24 and the area stay information received from the area stay information acquisition/notification unit 22 together in the database device. The area walking/stopping pattern storage/reading unit 27 also stores past history information of the user (i.e. the combination of past area stay information and walking/stopping time-series pattern of the user) in the database device.

Moreover, the area walking/stopping pattern storage/reading unit 27 has a function of, upon reception of latest stay area information from the area stay information acquisition/notification unit 22, searching the history information stored in the database device for history information indicating that the user stayed in the same area in the past. The area walking/stopping pattern storage/reading unit 27 also has a function of, in the case of determining that there is the history information indicating that the user stayed in the same area in the past, reading a walking/stopping time-series pattern of the user's past stay in the same area from the database device. The area walking/stopping pattern storage/reading unit 27 further has a function of supplying (outputting) the read walking/stopping time-series pattern to the area behavior feature value calculation unit 251 together with the latest walking/stopping time-series pattern.

The area behavior feature value calculation unit 251 is actually realized by the CPU of the information processing device operating according to the program. The area behavior feature value calculation unit 251 has a function of receiving the latest stay area information and the walking/stopping time-series pattern of the stay from the area walking/stopping pattern storage/reading unit 27. The area behavior feature value calculation unit 251 also has a function of, in the case where there is the history information indicating that the user stayed in the same area in the past, simultaneously receiving the area stay information and the walking/stopping time-series pattern of the user's past stay from the area walking/stopping pattern storage/reading unit 27.

Moreover, the area behavior feature value calculation unit 251 has a function of calculating a behavior feature value, using the received latest area stay information and walking/stopping time-series pattern and past history (area stay information and walking/stopping time-series pattern). The area behavior feature value calculation unit 251 also has a function of outputting the calculated behavior feature value to the area interest level determination unit 26.

For instance, the area behavior feature value calculation unit 251 calculates a feature value such as the total sum or mean value of the stopping time within the time during which the user stays in the area, the ratio between the walking time and the stopping time, and the like, on a stay-time basis or in combination with the stay history. The area behavior feature value calculation unit 251 then supplies (outputs) the calculated behavior feature value to the area interest level determination unit 26.

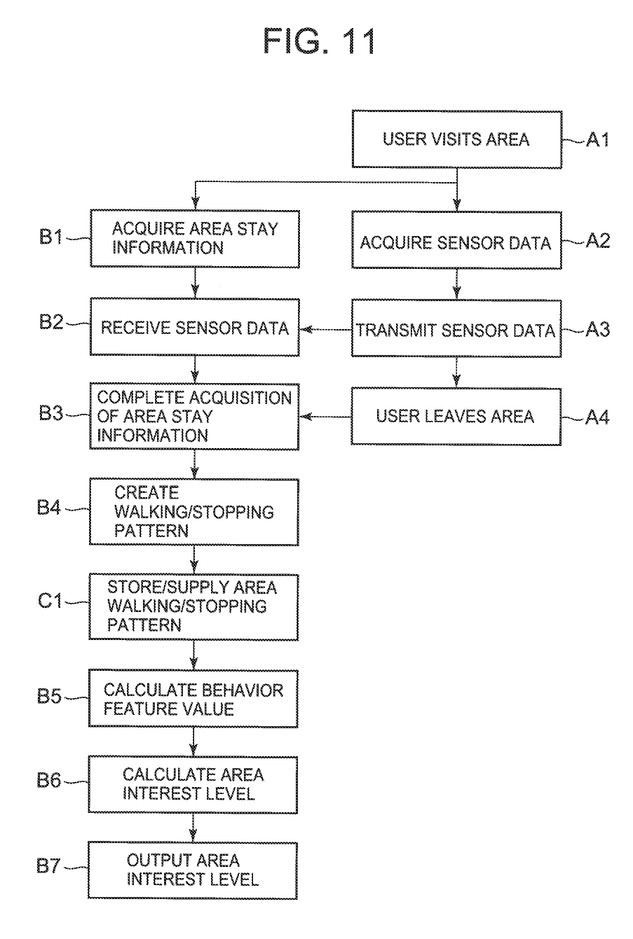

The following describes operations. FIG. 11 is a flowchart showing an example of a process of measuring an interest level in an area on a user basis in the interest level measurement system in Exemplary Embodiment 5. In this exemplary embodiment, the processes of steps A1 to A3 and steps B1 and B2 executed by the sensor terminal 1 and the sensor data reception unit 21 in FIG. 11 are respectively the same as those in Exemplary Embodiment 4.

When the user leaves the area (step A4), the area stay information acquisition/notification unit 22 completes time information of the user's stay in the area, and outputs the notification information to the sensor data storage/reading unit 23 and the area walking/stopping pattern storage/reading unit 27. The sensor data storage/reading unit 23 extracts, from the database device, sensor time-series data for the time period during which the user stays in the area, and supplies (outputs) the sensor time-series data to the walking/stopping pattern creation unit 24 (step B3).

In this exemplary embodiment, the process of step B4 executed by the walking/stopping pattern creation unit 24 is the same as that in Exemplary Embodiment 4.

Next, the area walking/stopping pattern storage/reading unit 27 stores the walking/stopping time-series pattern received from the walking/stopping pattern creation unit 24 in the database device, together with the area stay information received from the area stay information acquisition/notification unit 22. The area walking/stopping pattern storage/reading unit 27 also supplies (outputs) the walking/stopping time-series pattern and the area stay information stored in the database device, to the area behavior feature value calculation unit 251 (step C1).

In step C1, the area walking/stopping pattern storage/reading unit 27 searches the history information stored in the database device for history information of the user's past stay in the same area. In the case of determining that there is the history information of the user's past stay in the same area, the area walking/stopping pattern storage/reading unit 27 extracts the area stay information and walking/stopping time-series pattern of the user's past stay from the database device and supplies (outputs) the extracted area stay information and walking/stopping time-series pattern to the area behavior feature value calculation unit 251, simultaneously with supplying (outputting) the latest area stay information and walking/stopping time-series pattern to the area behavior feature value calculation unit 251.

Next, the area behavior feature value calculation unit 251 receives the latest area stay information and the walking/stopping time-series pattern of the stay, from the area walking/stopping pattern storage/reading unit 27. Further, in the case where there is the history information of the user's past stay in the same area, the area behavior feature value calculation unit 251 simultaneously receives the area stay information and the walking/stopping time-series pattern of the past stay. The area behavior feature value calculation unit 251 calculates a behavior feature value, using the latest area stay information and walking/stopping time-series pattern and the past history information (area stay information and walking/stopping time-series pattern) (step B5). For instance, the area behavior feature value calculation unit 251 calculates a feature value such as the total sum or mean value of the stopping time within the time during which the user stays in the area, the ratio between the walking time and the stopping time, the stopping count, and the like, on a stay-time basis or in combination with the stay history. The area behavior feature value calculation unit 251 supplies (outputs) the calculated behavior feature value to the area interest level determination unit 26.

Next, the area interest level determination unit 26 calculates an area interest level in the area on a user basis, using the behavior feature value received from the area behavior feature value calculation unit 251 (step B6). For example, the area interest level determination unit 26 performs an operation such as comparing magnitudes of the received behavior feature value and a preset threshold, to determine the user's interest level in the area such as the user being interested in no product or the user being very interested in the area.

Moreover, in the case where it is determined that there is the history information of the user's past stay in the same area, the area interest level determination unit 26 performs an operation such as comparison with a past interest level or comparison with an average interest level of the whole history information. For example, the area interest level determination unit 26 determines, from the comparison with the past interest level, that the user is more interested in the area than usual, that the degree of the user's interest in the area is lower than usual, or the like, and supplies (outputs) the determination result to the interest level output device 3.

Next, the interest level output device 3 performs control of outputting the area interest level information received from the area interest level determination unit 26 (step B7). As an example, the interest level output device 3 transmits the obtained area interest level information to a mobile phone possessed by the user, to display the area interest level information on a display unit of the mobile phone. As another example, the interest level output device 3 performs controls such as transmitting the obtained area interest level information to a content server for creating recommendation information to the user and the like.

As described above, according to this exemplary embodiment, in addition to the advantageous effects of Exemplary Embodiment 4, the interest level measurement system can determine the interest level in each individual area stay with respect to the user's usual interest level, through the use of the past history information of the user. This enables fine interest level determination suitable for each individual user, such as finding a different tendency of interest from usual or recognizing a time-series change of the degree of the user's interest.

The interest level measurement system in this exemplary embodiment may include the non-walking behavior pattern creation unit 28 in Exemplary Embodiment 1 to create the non-walking behavior time-series pattern in addition to the walking/stopping time-series pattern, and calculate the area behavior feature value using not only the walking/stopping time-series pattern but also the non-walking behavior time-series pattern to determine the area interest level. According to such a structure, the detailed behavior status of the user such as whether or not the user is in a state of a non-walking behavior can be recognized to determine the interest level in each individual area stay with respect to the user's usual interest level.

The interest level measurement system in this exemplary embodiment may include the terminal posture pattern creation unit 29 in Exemplary Embodiment 2 to create the terminal posture time-series pattern in addition to the walking/stopping time-series pattern, and calculate the area behavior feature value using not only the walking/stopping time-series pattern but also the terminal posture time-series pattern to determine the area interest level. According to such a structure, the behavior status of the user (e.g. a state in which the user is viewing the display screen of the sensor terminal 1, a state in which the user is substantially changing his/her posture) can be indirectly recognized from the posture of the sensor terminal 1, to determine the interest level in each individual area stay with respect to the user's usual interest level.

The interest level measurement system in this exemplary embodiment may include both the non-walking behavior pattern creation unit 28 in Exemplary Embodiment 1 and the terminal posture pattern creation unit 29 in Exemplary Embodiment 2.

The interest level measurement system in this exemplary embodiment may include the environment information acquisition/communication unit 40 in Exemplary Embodiment 3. According to such a structure, the area status such as the number of people, the temperature, and the humidity in the area can also be recognized to determine the interest level in each individual area stay with respect to the user's usual interest level.

### Exemplary Embodiment 6

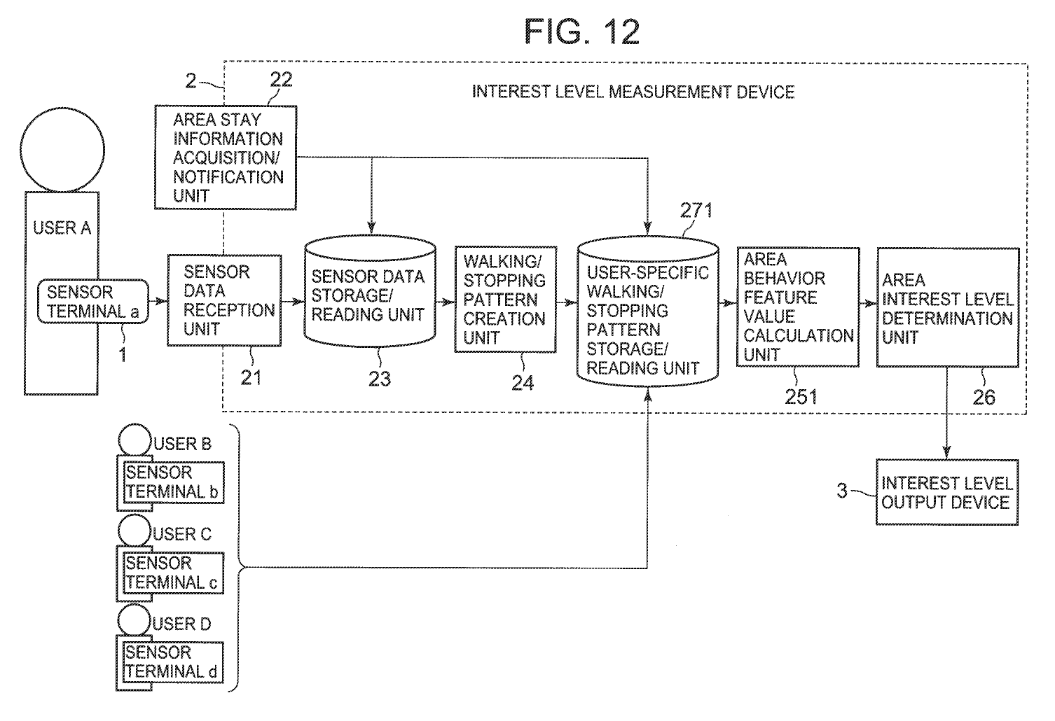

Exemplary Embodiment 6 of the present invention is described below, with reference to drawings. FIG. 12 is a block diagram showing an example of a structure of an interest level measurement system in Exemplary Embodiment 6. As shown in FIG. 12, the interest level measurement system in Exemplary Embodiment 6 includes a plurality of sensor terminals 1 as well as the components shown in FIG. 10, where the plurality of sensor terminals 1 are respectively possessed by a plurality of users. Besides, Exemplary Embodiment 6 differs from Exemplary Embodiment 5 in that the interest level measurement system includes a user-specific walking/stopping pattern storage/reading unit 271 instead of the area walking/stopping pattern storage/reading unit 27 shown in FIG. 10.

The user-specific walking/stopping pattern storage/reading unit 271 is actually realized by the CPU of the information processing device operating according to the program and a database device such as a magnetic disk device or an optical disc device. The user-specific walking/stopping pattern storage/reading unit 271 stores a walking/stopping time-series pattern received from the walking/stopping pattern creation unit 24 and area stay information received from the area stay information acquisition/notification unit 22 in the database device, together with ID information for identifying a user. The user-specific walking/stopping pattern storage/reading unit 271 equally stores a combination of area stay information and a walking/stopping time-series pattern of another user in the database device.

Moreover, the user-specific walking/stopping pattern storage/reading unit 271 has a function of, upon reception of stay area information of a user A from the area stay information acquisition/notification unit 22, searching the database device for information of a user who stayed in the same area. The user-specific walking/stopping pattern storage/reading unit 271 also has a function of, in the case of determining that there is the information of the user who stayed in the same area in the past, reading a walking/stopping time-series pattern of the user's stay from the database device, and supplying (outputting) the read walking/stopping time-series pattern to the area behavior feature value calculation unit 251 together with the walking/stopping time-series pattern of the user A.

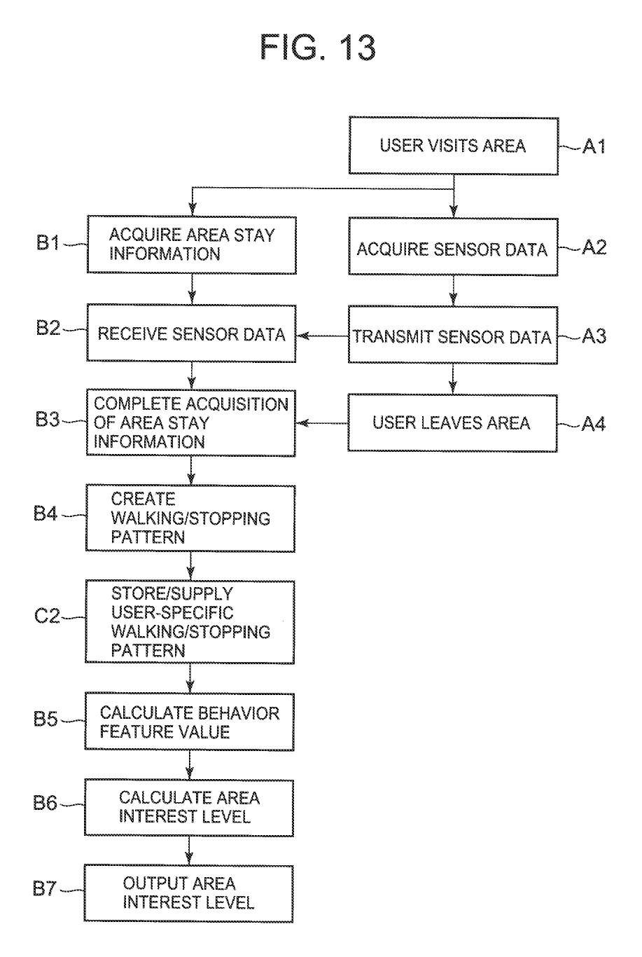

The following describes operations. FIG. 13 is a flowchart showing an example of a process of measuring an interest level in an area on a user basis in the interest level measurement system in Exemplary Embodiment 6. In this exemplary embodiment, the processes of steps A1 to A3 and steps B1 and B2 executed by the sensor terminal 1 and the sensor data reception unit 21 in FIG. 13 are respectively the same as those in Exemplary Embodiment 5.

When the user A leaves the area (step A4), the area stay information acquisition/notification unit 22 completes time information of the user A's stay in the area, and outputs the notification information to the sensor data storage/reading unit 23 and the user-specific walking/stopping pattern storage/reading unit 271. The sensor data storage/reading unit 23 extracts, from the database device, sensor time-series data for the time period during which the user A stays in the area, and supplies (outputs) the sensor time-series data to the walking/stopping pattern creation unit 24 (step B3).

In this exemplary embodiment, the process of step B4 executed by the walking/stopping pattern creation unit 24 is the same as that in Exemplary Embodiment 4.

The user-specific walking/stopping pattern storage/reading unit 271 stores the walking/stopping time-series pattern received from the walking/stopping pattern creation unit 24 in the database device, together with the area stay information received from the area stay information acquisition/notification unit 22 and ID information for identifying the user. The user-specific walking/stopping pattern storage/reading unit 271 also supplies (outputs) the walking/stopping time-series pattern and the area stay information of the user A stored in the database device, to the area behavior feature value calculation unit 251 (step C2).

In step C2, the user-specific walking/stopping pattern storage/reading unit 271 searches the data stored in the database device for history information corresponding to when a user other than the user A stayed in the same area. In the case of determining that there is the history information of the other user's stay in the same area, the user-specific walking/stopping pattern storage/reading unit 271 extracts the area stay information and walking/stopping time-series pattern of the other user's past stay from the database device and supplies (outputs) the extracted area stay information and walking/stopping time-series pattern to the area behavior feature value calculation unit 251, simultaneously with supplying (outputting) the area stay information and the walking/stopping time-series pattern of the user A to the area behavior feature value calculation unit 251.

The area behavior feature value calculation unit 251 receives the area stay information of the user A and the walking/stopping time-series pattern of the stay, from the user-specific walking/stopping pattern storage/reading unit 271. Further, in the case where there is the history information of the other user's stay in the same area, the area behavior feature value calculation unit 251 simultaneously receives the area stay information and the walking/stopping time-series pattern of the other user. The area behavior feature value calculation unit 251 calculates a behavior feature value, using the walking/stopping time-series pattern of the user A and the walking/stopping time-series pattern of the other user (step B5). For instance, the area behavior feature value calculation unit 251 calculates a feature value such as the total sum or mean value of the stopping time within the time during which the user stays in the area, the ratio between the walking time and the stopping time, the stopping count, and the like, on a user basis or in combination with the other user. The area behavior feature value calculation unit 251 supplies (outputs) the calculated behavior feature value to the area interest level determination unit 26.

The area interest level determination unit 26 calculates an area interest level in the area on a user basis, using the behavior feature value received from the area behavior feature value calculation unit 251 (step B6). For example, the area interest level determination unit 26 performs an operation such as comparing magnitudes of the received behavior feature value and a preset threshold, to determine the user A's interest level in the area such as the user A being interested in no product or the user A being very interested in the area.

Moreover, in the case where it is determined that there is the history information of the other user's stay in the same area, the area interest level determination unit 26 extracts a feature value such as the similarity between the user A and the other user, the specificity of the user A, and the relative degree of the user A's interest, with respect to the average interest level of all users or the like. The area interest level determination unit 26 supplies (outputs) the determination result to the interest level output device 3.

Next, the interest level output device 3 performs control of outputting the area interest level information received from the area interest level determination unit 26 (step B7). As an example, the interest level output device 3 transmits the obtained area interest level information to a mobile phone possessed by the user, to display the area interest level information on a display unit of the mobile phone. As another example, the interest level output device 3 performs controls such as transmitting the obtained area interest level information to a content server for creating recommendation information to the user and the like.

As described above, according to this exemplary embodiment, in addition to the advantageous effects of Exemplary Embodiment 4, the interest level measurement system can perform comparison with the average interest level through the use of the walking/stopping time-series pattern of another user. Thus, the similarity between the plurality of users and the specificity of the specific user can be extracted, and also the feature value such as the relative degree of interest in comparison between the plurality of users can be extracted. This enables objective and fine interest level determination.

The interest level measurement system in this exemplary embodiment may include the non-walking behavior pattern creation unit 28 in Exemplary Embodiment 1 to create the non-walking behavior time-series pattern in addition to the walking/stopping time-series pattern, and calculate the area behavior feature value using not only the walking/stopping time-series pattern but also the non-walking behavior time-series pattern to determine the area interest level. According to such a structure, the detailed behavior status of the user such as whether or not the user is in a state of a non-walking behavior can be recognized to extract the similarity between the plurality of users and the specificity of the specific user and also extract the feature value such as the relative degree of interest in comparison between the plurality of users, which enables objective and fine interest level determination.

The interest level measurement system in this exemplary embodiment may include the terminal posture pattern creation unit 29 in Exemplary Embodiment 2 to create the terminal posture time-series pattern in addition to the walking/stopping time-series pattern, and calculate the area behavior feature value using not only the walking/stopping time-series pattern but also the terminal posture time-series pattern to determine the area interest level. According to such a structure, the behavior status of the user (e.g. a state in which the user is viewing the display screen of the sensor terminal 1, a state in which the user is substantially changing his/her posture) can be indirectly recognized from the posture of the sensor terminal 1 to extract the similarity between the plurality of users and the specificity of the specific user and also extract the feature value such as the relative degree of interest in comparison between the plurality of users, which enables objective and fine interest level determination.

The interest level measurement system in this exemplary embodiment may include both the non-walking behavior pattern creation unit 28 in Exemplary Embodiment 1 and the terminal posture pattern creation unit 29 in Exemplary Embodiment 2.

The interest level measurement system in this exemplary embodiment may include the environment information acquisition/communication unit 40 in Exemplary Embodiment 3. According to such a structure, the area status such as the number of people, the temperature, and the humidity in the area can also be recognized to extract the similarity between the plurality of users and the specificity of the specific user and also extract the feature value such as the relative degree of interest in comparison between the plurality of users, which enables objective and fine interest level determination.

### Example 1

Example 1 of the present invention is described below, with reference to drawings. An interest level measurement system in Example 1 corresponds to a more concrete example of the interest level measurement system in Exemplary Embodiment 1.

In this example, a mobile phone carried by a user transmits behavior information of the user to the interest level measurement device 2 using an accelerometer equipped in the mobile phone. The interest level measurement device 2 calculates the user's interest level based on obtained acceleration data, and transmits the calculated interest level to a content server so that the interest level is used for selecting information distributed to the user.

Consider a situation where the user carrying the mobile phone enters a store. In this case, a GPS receiver and the accelerometer equipped in the mobile phone acquire position information and acceleration information of the user at a regular time interval. In this example, it is supposed that the area stay information acquisition/notification unit 21 is included in the mobile phone together with the GPS receiver.

When the user enters the store, the GPS receiver becomes incapable of positioning continuously for a fixed time period such as 30 seconds, as an example. This triggers the area stay information acquisition/notification unit 21 to determine a position at which the GPS receiver was capable of positioning last time, as a stay area. Let Tᵢₙ be a time at which the GPS receiver was capable of positioning last time, and t_{GPS} be a positioning time interval of the GPS receiver. The area stay information acquisition/notification unit 21 specifies a time Tᵢₙ+t_{GPS}/2 as a time at which the user enters the area, and acquires (calculates) the time as a stay start time. Meanwhile, the mobile phone transmits acceleration data from the stay start time onward, to the sensor data reception unit 21 in the interest level measurement device 2. The sensor data reception unit 21 supplies (outputs) sensor time-series data to the sensor data storage/reading unit 23, and the sensor data storage/reading unit 23 stores the received data in a database device.

Each time a fixed amount of acceleration data are accumulated, the mobile phone transmits the data to the sensor data reception unit 21. This is repeated until the GPS receiver becomes capable of positioning again. When the GPS receiver in the mobile phone becomes capable of positioning again, the area stay information acquisition/notification unit 22 compares latest position information and position information acquired immediately before the GPS receiver becomes incapable of positioning. In the case of determining that the latest position information matches, within a predetermined range such as 10 m, the position information acquired immediately before the GPS receiver becomes incapable of positioning, the area stay information acquisition/notification unit 22 assumes (determines) that the user stays in the area. Let Tₒᵤₜ be a time at which the GPS receiver becomes capable of positioning again. The area stay information acquisition/notification unit 22 specifies a time Tₒᵤₜ−t_{GPS}/2 as a time at which the user leaves the area, and acquires (calculates) the time as a stay end time. The mobile phone transmits sensor time-series data up to the stay end time, to the sensor data reception unit 21.

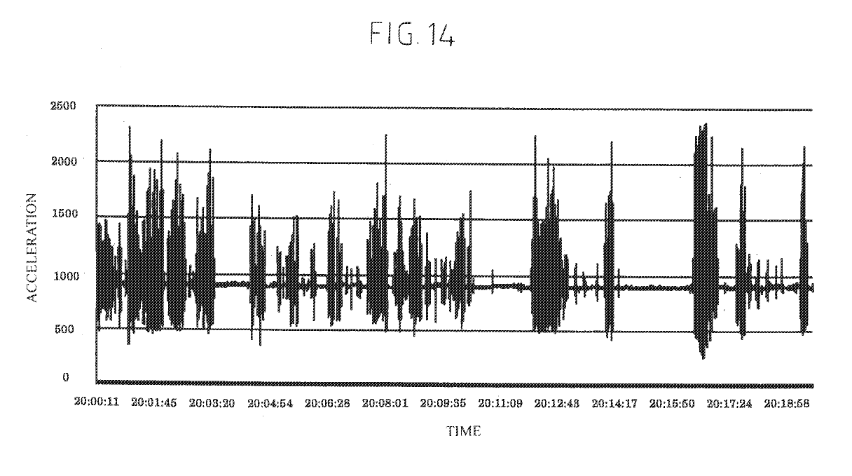

Since the sensor data storage/reading unit 23 stores the sensor time-series data for the stay time, the sensor data storage/reading unit 23 supplies (outputs) the sensor time-series data to the walking/stopping pattern creation unit 24 and the non-walking behavior pattern creation unit 28. FIG. 14 is an explanatory diagram showing an example of acceleration data actually obtained using the mobile phone from when the user enters the store to when the user leaves the store.

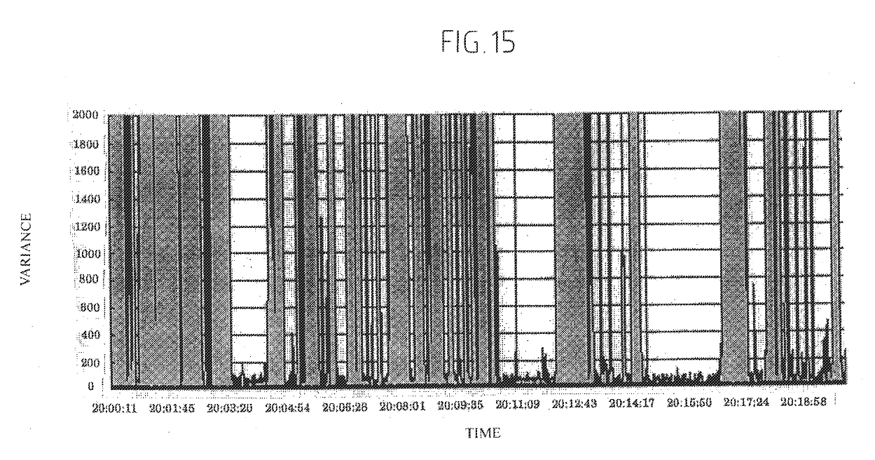

The walking/stopping pattern creation unit 24 calculates an acceleration variance per second, based on the received accelerometer time-series data. FIG. 15 is an explanatory diagram showing a graph of a variance calculated based on the acceleration data shown in FIG. 14.

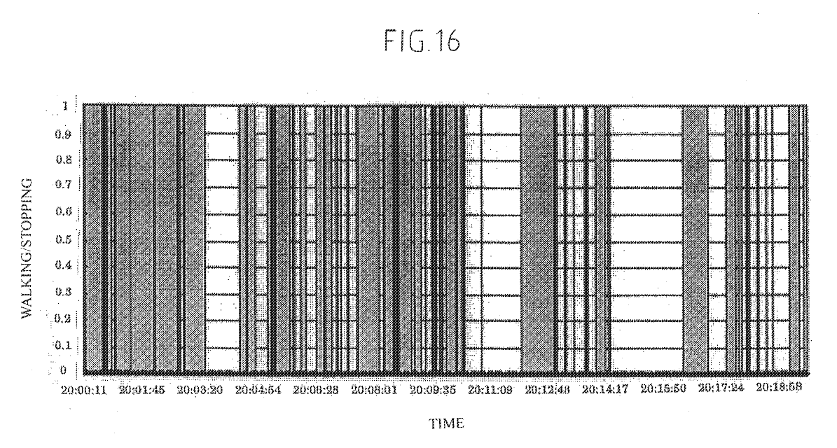

The walking/stopping pattern creation unit 24 creates a walking/stopping time-series pattern, by determining that the user is in a walking state in the case where the variance is not less than 1000 (mG)² and the user is in a stopping state in the case where the variance is less than 1000 (mG)². The walking/stopping pattern creation unit 24 supplies (outputs) the created walking/stopping time-series pattern to the behavior feature value calculation unit 25. FIG. 16 is an explanatory diagram showing data obtained by binarizing the variance data shown in FIG. 15 according to the walking/stopping state. In the example of the walking/stopping time-series pattern shown in FIG. 16, the walking state is set to 1 and the stopping state is set to 0.

The non-walking behavior pattern creation unit 28 calculates an acceleration variance based on the received accelerometer time-series data, and calculates a gravity vector variance based on the acceleration. The non-walking behavior pattern creation unit 28 determines whether or not the user is in a state of a non-walking behavior, based on the calculated acceleration variance and gravity vector variance.

FIG. 17 is an explanatory diagram showing an example of a determination algorithm according to which the interest level measurement device 2 determines whether the user is in a walking state, a stopping state, or a state of a non-walking behavior. As shown in FIG. 17, the interest level measurement device 2 determines, for example, whether or not the calculated acceleration variance is more than a predetermined threshold, by the functions of the walking/stopping pattern creation unit 24 and the non-walking behavior pattern creation unit 28 (step S10). In the case of determining that the acceleration variance is more than the predetermined threshold, the interest level measurement device 2 determines whether or not an acceleration peak interval is within a predetermined range (e.g. about 500 ms to 1200 ms), by the functions of the walking/stopping pattern creation unit 24 and the non-walking behavior pattern creation unit 28 (step S11). In the case where the acceleration peak interval is within the predetermined range, the interest level measurement device 2 determines that the user is in a walking state, by the functions of the walking/stopping pattern creation unit 24 and the non-walking behavior pattern creation unit 28 (step S12). In the case where the acceleration peak interval is not within the predetermined range, the interest level measurement device 2 determines that the user is in a state of a non-walking behavior, by the functions of the walking/stopping pattern creation unit 24 and the non-walking behavior pattern creation unit 28 (step S13).

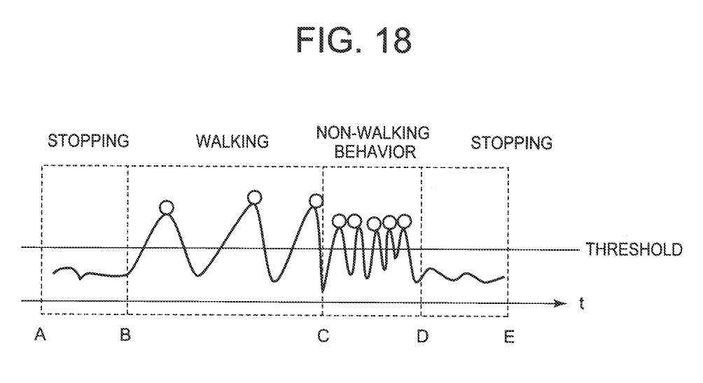

FIG. 18 is an explanatory diagram showing a specific example of the acceleration peak interval determination method in step S11. In the example shown in FIG. 18, regarding a section from a time B to a time C as an example, the non-walking behavior pattern creation unit 28 determines that the peak interval is within the predetermined range (e.g. about 500 ms to 1200 ms), and so determines that the user is in a walking state. Regarding a section from the time C to a time D where the peak interval is short, on the other hand, the non-walking behavior pattern creation unit 28 determines that the peak interval is not within the predetermined range (e.g. about 500 ms to 1200 ms), and so determines that the user is in a state of a non-walking behavior. The range of the peak interval within which it can be determined that the user is in a walking state may be specified beforehand based on actual measurement or the like.

Alternatively, the non-walking behavior pattern creation unit 28 may count the number of times the acceleration peak interval is not within the predetermined range during a certain time period and, in the case where the counted number is not less than a predetermined threshold, determine that the user is in a state of a non-walking behavior. The non-walking behavior pattern creation unit 28 may calculate an acceleration peak interval mean value during a certain time period and, in the case where the calculated mean value is not within a predetermined range, determine that the user is in a state of a non-walking behavior.

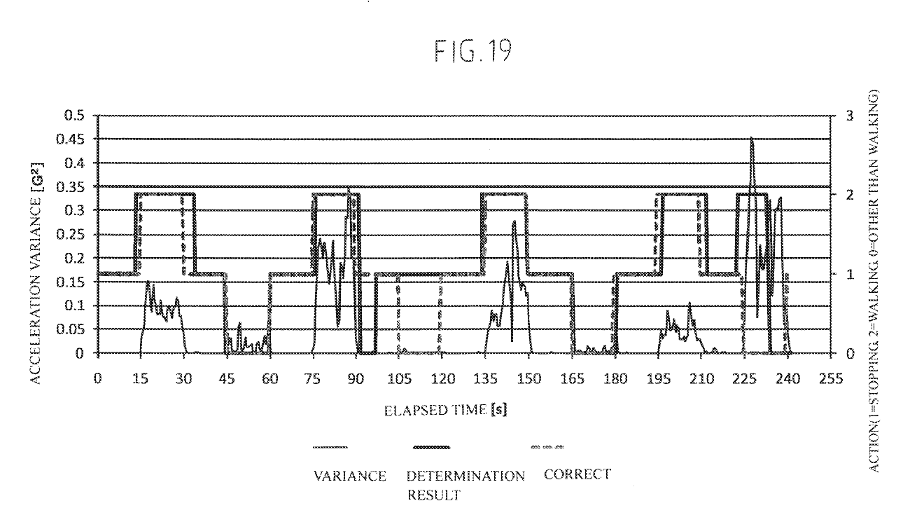

FIG. 19 is an explanatory diagram showing a specific example of a determination result of determining, by actual acceleration measurement, whether or not the user is in a state of a non-walking behavior. As an example, FIG. 19 shows a measurement result when a person carrying an accelerometer performs the following actions for 15 seconds each: stop→walk→stop→non-walking behavior (squat)→stop→walk→stop→non-walking behavior (twist the body)→stop→walk→stop→non-walking behavior (stoop)→stop→walk→stop→non-walking behavior (swing the terminal). In the example shown in FIG. 19, for instance, it is determined that the peak interval is within the predetermined range and so the user is in a walking state in a section from an elapsed time of 15 seconds to an elapsed time of 30 seconds, whereas it is determined that the peak interval is not within the predetermined range and so the user is in a state of a non-walking behavior in a section from an elapsed time of 45 seconds to an elapsed time of 60 seconds, though there are slight measurement errors.

In FIG. 17, in the case of determining that the calculated acceleration variance is not more than the predetermined threshold, the interest level measurement device 2 determines whether or not the calculated gravity vector variance is more than a predetermined threshold, by the functions of the walking/stopping pattern creation unit 24 and the non-walking behavior pattern creation unit 28 (step S14). In the case of determining that the gravity vector variance is not more than the predetermined threshold, the interest level measurement device 2 determines that the user is in a stopping state, by the functions of the walking/stopping pattern creation unit 24 and the non-walking behavior pattern creation unit 28 (step S15). In the case of determining that the gravity vector variance is more than the predetermined threshold, on the other hand, the interest level measurement device 2 determines that the user is in a stopping state but also in a state of moving his/her body in the stopping place, by the functions of the walking/stopping pattern creation unit 24 and the non-walking behavior pattern creation unit 28 (step S16).

The behavior feature value calculation unit 25 calculates, as a behavior feature value, a total walking time Tw, a total stopping time Ts, a total non-walking behavior time (non-walking time) To, and a total stopping count C within the stay time, based on the obtained walking/stopping time-series pattern and non-walking behavior time-series data. The behavior feature value calculation unit 25 supplies (outputs) the obtained values of Tw, Ts, To, and C to the area interest level determination unit 26.

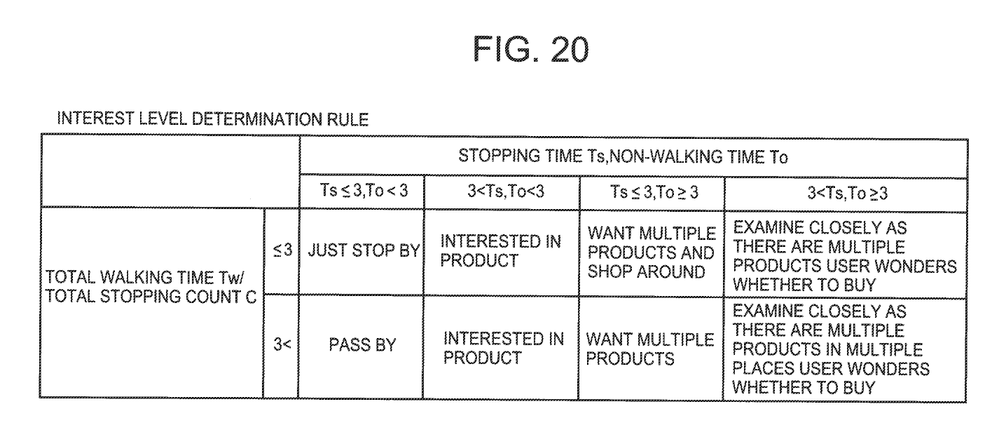

The area interest level determination unit 26 determines the user's area interest level using the received values of Tw, Ts, To, and C based on, for example, a relationship between feature values and interest levels obtained from a result of an experiment conducted beforehand. FIG. 20 is a diagram showing an example of a table of such a relationship between behavior feature values and user interest levels. As shown in FIG. 20, for example in the case where not only the stopping time Ts is long but also the non-walking time To is long, the area interest level determination unit 26 can determine that the user is seeing a product with interest while squatting or stretching, and so can determine that the user is very interested in the product. The area interest level determination unit 26 supplies (outputs) the obtained interest level and the area stay information received from the area stay information acquisition/notification unit 22, to the interest level output device 3.

The interest level output device 3 transmits the user information and the area stay information and interest level information of the user, to the content server via a communication network. For example, the content server stores store information, store genre, prices of displayed products, and the like in a database device in association with area information, and has a function of searching for a product or a store of the same genre. Based on the area information and the interest level information indicating that the user is very interested in the store, which are received from the interest level output device 3, the content server searches for recommendation information relating to the same genre of store as the store in which the user stays and its product, and selects the recommendation information. The content server distributes the selected recommendation information to the mobile phone of the user via a communication network.

Here, a table of a relationship between feature values and interest levels that differs depending on the area may be prepared in advance, and stored in storage means (e.g. a storage device such as a magnetic disk device or a memory) by the area interest level determination unit 26 beforehand. The area interest level determination unit 26 may then determine the user's interest level, by selectively using the table of the relationship between feature values and interest levels based on the received stay area position information.

As described above, according to this example, through the use of the behavior feature value calculated from the walking/stopping time-series pattern and the non-walking behavior time-series pattern of the user, the detailed behavior status of the user can be recognized, and so the characteristics of the degree and tendency of interest that differ depending on the user, such as the purpose of visiting the store, the number of products the user is interested in, and the degree of interest can be finely determined and recognized. Therefore, the detailed behavior status of the user can be recognized to calculate the fine interest level in each area by taking into account the degree and tendency of interest on a user basis.

Though this example describes the case of outputting conceptual information such as “just stop by” or “interested in product” as the interest level determination result as shown in FIG. 20, the information output as the interest level is not limited to those shown in this example. For instance, the area interest level determination unit 26 may calculate the user's interest level as a numeric value and output the calculated numeric value as the determination result.

In the case of calculating the interest level as a numeric value, the area interest level determination unit 26 may, for example, employ any of the following two methods: (method 1): an interest level calculation model is created beforehand, and the interest level is calculated using the calculation model; and (method 2): correct data is collected beforehand, and a relationship between correct data and user actions is specified.

In the case of employing (method 1) as an example, the area interest level determination unit 26 may calculate the interest level using the following equation (1).

$$( interest level in area ) = \frac{( stay time ) \times ( stopping count )}{( walking time )} \times ( coefficient ) \qquad equation ( 1 )$$

In the case of employing (method 2) as an example, the area interest level determination unit 26 conducts a questionnaire or user behavior analysis beforehand and, based on the obtained result, calculates the user's interest level in each floor of a store or the like. Upon calculating the interest level, the area interest level determination unit 26 learns and models its relationship with user actions. For example, the area interest level determination unit 26 sets a learning model “(interest level in floor)=f(floor, action during stay on floor)”, and learns the model f using a neural network, regression analysis, and so on. By applying the user's action during his/her stay on the floor to the learned model, the area interest level determination unit 26 can calculate the user's interest level in the floor.

The interest level in the floor may be set, for example, based on specific user behaviors (e.g. seeing a product, touching a product) observed or surveyed by collecting questionnaires. For instance, the applicant of the present application conducted a sequential survey on times of seeing or touching products during actual stay on the floor, and can define the user's interest level based on the survey result as shown in the following equation (2).

(interest level)=(1+α×(number of times of seeing product or taking product in hand))×(floor stay time) equation (2)

The applicant actually conducted an investigation. As a result of learning by multiple regression analysis according to the equation (2) using, as the values indicating actions during floor stay, the stopping count, the stopping time, the walking count, the walking time, the non-walking behavior count, and the non-walking behavior time, the applicant was able to obtain a model shown in the following equation (3). The investigation was conducted where α=0.5.

$$( interest level ) = - 209.73 + 24.24 \times ( stopping count ) + 0.00071 \times ( stopping time ) + 0.41 \times ( walking count ) + 0.0011 \times ( walking time ) - 17.4 \times ( non \text{-} walking behavior count ) + 0.0032 \times ( non \text{-} walking behavior time ) \qquad equation ( 3 )$$

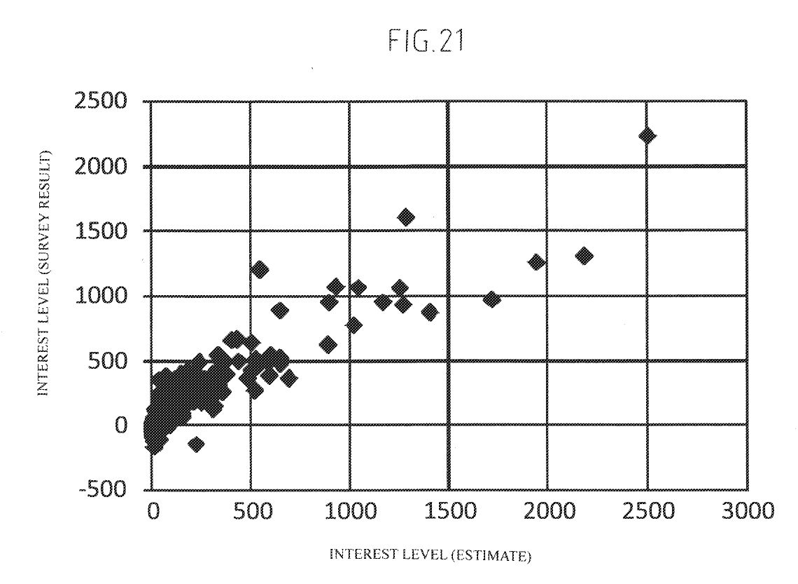

FIG. 21 is an explanatory diagram showing an investigation result obtained by plotting the interest level defined based on the above-mentioned survey result and the interest level estimated using the model expressed by the equation (3). From the investigation result shown in FIG. 21, it can be understood that there is a high correlation between the survey result of the interest level and the estimated interest level. This demonstrates that the interest level can be estimated from the user's action using the model expressed by the equation (3).

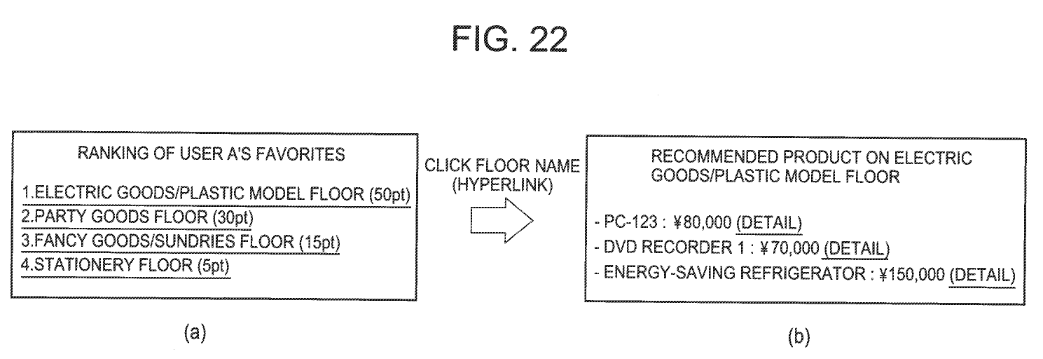

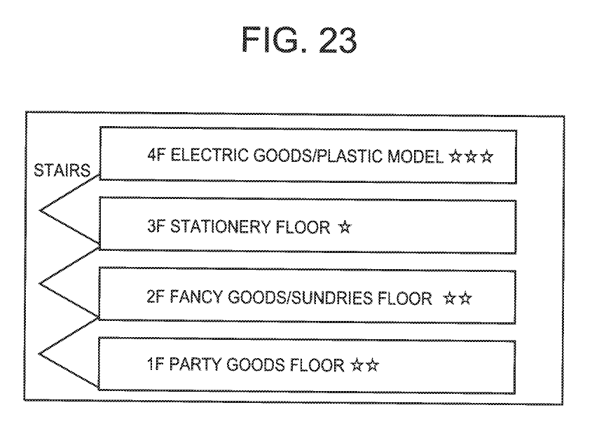

The interest level determined by the interest level measurement device 2 may be displayed on a display device in the interest level output device 3 or the sensor terminal 1. FIGS. 22 and 23 are each an explanatory diagram showing a specific example of a display screen displayed based on the interest level determination result. For example, the user's past interest levels may be summarized for each floor of the store and the like, and displayed in a display screen of a ranking of favorites as shown in FIG. 22(a). Here, for example, floor names and recommended product lists may be linked to each other so that, when the user selects a floor name on the display screen in FIG. 22(a), a display screen of a recommended product list corresponding to the selected floor is displayed as shown in FIG. 22(b).

Moreover, for example in the case of displaying a map in the store or floor maps, information of floors of high interest to the user may be acquired based on past history information so that the user's interest level is represented by the number of stars on the display screen as shown in FIG. 23.

Though this example describes the case of determining, when the user is performing some kind of action, whether the user is in a walking state or in a state of a non-walking behavior other than walking, finer determination of what kind of non-walking behavior the user is performing may also be made. For instance, in the case of determining that the acceleration peak interval is not within the predetermined range (e.g. about 500 ms to 1200 ms), the non-walking behavior pattern creation unit 28 may further divide the acceleration peak interval range for determination, to enable determination of a specific action such as going up stairs.

### Example 2

Example 2 of the present invention is described below, with reference to drawings. An interest level measurement system in Example 2 corresponds to a more concrete example of the interest level measurement system in Exemplary Embodiment 2. Since the operations up to the creation of the walking/stopping time-series pattern in Example 2 are the same as those in Example 1, their description is omitted.

The terminal posture pattern creation unit 29 calculates a gravity vector indicating the posture of the sensor terminal 1, based on the received accelerometer time-series data. The terminal posture pattern creation unit 29 may calculate the gravity vector based on the acceleration by employing, for example, any of the following two methods: (method A): method of calculating the gravity vector by acceleration vector averaging; and (method B): method of calculating the gravity vector by frequency analysis.

In the case of employing (method A) as an example, the terminal posture pattern creation unit 29 can calculate the gravity vector by averaging the acceleration vector within a fixed time period. For instance, when the acceleration vector is denoted by aₜ=(a_{t, x}, a_{t, y}, a_{t, z}), the terminal posture pattern creation unit 29 can calculate the elements of the gravity vector to obtain the gravity vector gₜ=(g_{t, x}, g_{t, y}, g_{t, z}), using the following equation (4).

A=\sqrt{(Σaₓ)²+(Σa_{y})²+(Σa_{z})²}

gₓ=(Σaₓ)/A

g_{y}=(Σa_{y})/A

g_{z}=(Σa_{z})/A equation (4)

In the case of employing (method B) as an example, the terminal posture pattern creation unit 29 first frequency-transforms the acceleration vector by Fourier transformation, wavelet transformation, or the like. The terminal posture pattern creation unit 29 then filters the frequency transformation result by low-pass filtering, to obtain the gravity vector.

The behavior feature value calculation unit 25A calculates, as a behavior feature value, the total walking time Tw, the total stopping time Ts, and the total stopping count C within the stay time, based on the obtained walking/stopping time-series pattern. The behavior feature value calculation unit 25A also calculates, as a behavior feature value, the similarity S and the gravity vector variance, based on the obtained terminal posture time-series data. The behavior feature value calculation unit 25A supplies (outputs) the obtained Tw, Ts, C, similarity S, and gravity vector variance to the area interest level determination unit 26A.

For example, suppose the user's posture when viewing the display screen of the sensor terminal 1 is defined as a reference posture which is denoted by a vector fₜ=(f_{t, x}, f_{t, y}, f_{t, z}). The behavior feature value calculation unit 25A can calculate the similarity S based on the reference posture fₜ and the gravity vector gₜ, using the following equation (5).

$$( The similarity S compared with the reference posture ) = cos θ = \frac{\vec{f} \cdot \vec{g}}{\vert \vec{f} \vert \vert \vec{g} \vert} \qquad equation ( 5 )$$

Moreover, the behavior feature value calculation unit 25A calculates, for example, a gravity vector variance Vg based on a vector set of the gravity vector gₜ within a fixed time period, and outputs the gravity vector variance Vg as a behavior feature value.

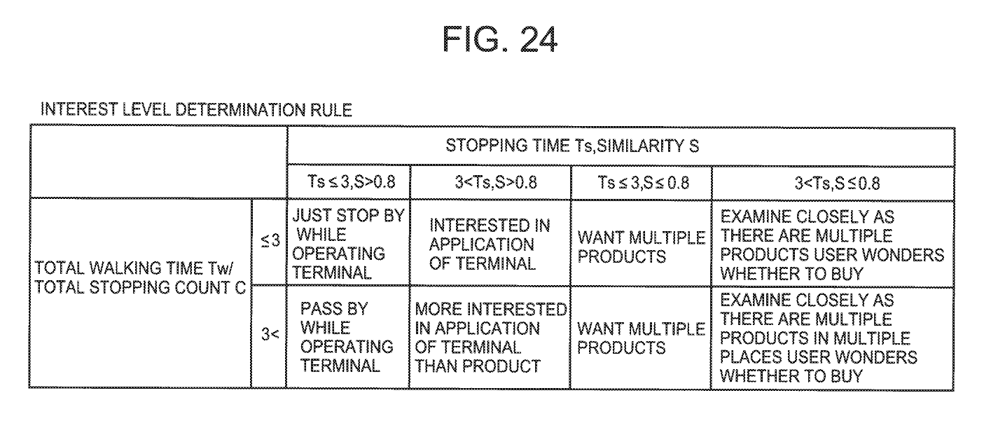

The area interest level determination unit 26A determines the user's area interest level using the received Tw, Ts, C, similarity S, and gravity vector variance Vg, based on, for example, a relationship between feature values and interest levels obtained from a result of an experiment conducted beforehand. FIG. 24 is a diagram showing an example of a table of such a relationship between behavior feature values and user interest levels. As shown in FIG. 24, for example in the case where the similarity S is high, the area interest level determination unit 26A can determine that the user is viewing the display screen of the sensor terminal 1 and performing an operation using an application or the like, on the ground that the posture is similar to the reference posture. Accordingly, even when the stopping time Ts is long to a certain extent, the area interest level determination unit 26A can determine that the user is interested in an application or the like on the terminal, and is not interested in a product. The area interest level determination unit 26A supplies (outputs) the obtained interest level and the area stay information received from the area stay information acquisition/notification unit 22, to the interest level output device 3.

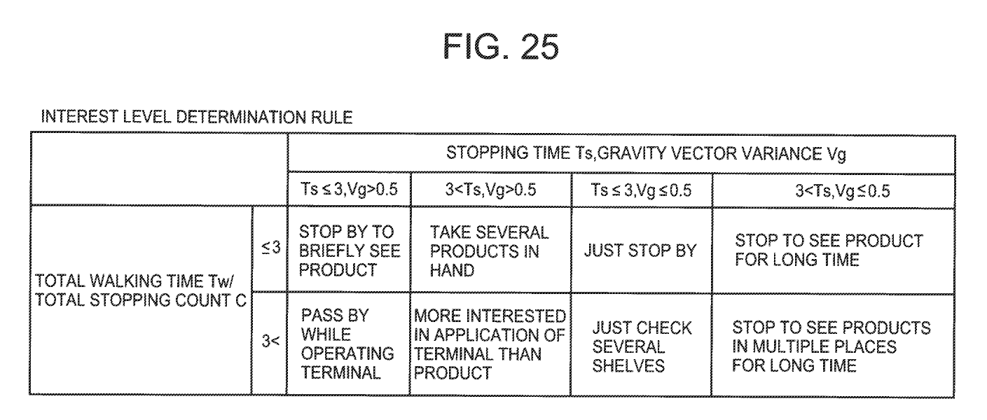

FIG. 25 is an explanatory diagram showing another example of a table of a relationship between behavior feature values and user interest levels. As shown in FIG. 25, for example in the case where the gravity vector variance Vg is high, the area interest level determination unit 26A can determine that the user is in a state of moving his/her body, and so can determine that the user is performing an action such as taking a product in hand. Accordingly, the area interest level determination unit 26A can determine that the user is interested in a nearby product.

Subsequently, the interest level output device 3 outputs the interest level determination result by the same operation as in Example 1.

As described above, according to this example, through the use of the behavior feature value calculated from the walking/stopping time-series pattern and the terminal posture time-series pattern of the user, the detailed behavior status of the user can be recognized indirectly from the posture of the sensor terminal 1, and so the characteristics of the degree and tendency of interest that differ depending on the user, such as the purpose of visiting the store, the number of products the user is interested in, and the degree of interest, can be finely determined and recognized. Therefore, the detailed behavior status of the user can be recognized to calculate the fine interest level in each area by taking into account the degree and tendency of interest on a user basis.

### Example 3

Example 3 of the present invention is described below, with reference to drawings. An interest level measurement system in Example 3 corresponds to a more concrete example of the interest level measurement system in Exemplary Embodiment 3. Since the operations up to the calculation of the behavior feature value in Example 3 are the same as those in Example 1, their description is omitted.

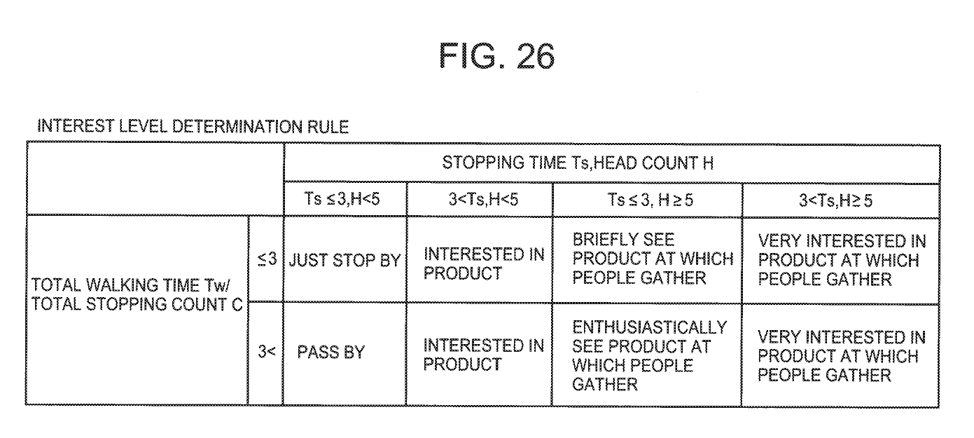

The area interest level determination unit 26B determines the user's area interest level using Tw, Ts, and C received as the behavior feature value and the received environment information based on, for example, a relationship between feature values and interest levels obtained from a result of an experiment conducted beforehand. FIG. 26 is a diagram showing an example of a table of such a relationship between behavior feature values and user interest levels. The example shown in FIG. 26 relates to the case where the head count H which is the number of people staying in the area is received as the environment information. As shown in FIG. 26, for example in the case where the head count H is high, the area interest level determination unit 26B can determine that the user is interested in a highly populated place. Accordingly, the area interest level determination unit 26B can output the interest level determination result such as “very interested in product at which people gather” in consideration of the environment information, as shown in FIG. 26. The area interest level determination unit 26B supplies (outputs) the obtained interest level and the area stay information received from the area stay information acquisition/notification unit 22, to the interest level output device 3.

Subsequently, the interest level output device 3 outputs the interest level determination result by the same operation as in Example 1.

As described above, according to this example, the user's interest level is determined based on not only the behavior feature value but also the environment information indicating the status in the area. Thus, in addition to the advantageous effects of Example 1, the characteristics of the degree and tendency of interest that differ depending on the user can be finely determined and recognized by also recognizing the area status such as the number of people, the temperature, and the humidity in the area.

### Example 4

Example 4 of the present invention is described below, with reference to drawings. An interest level measurement system in Example 4 corresponds to a more concrete example of the interest level measurement system in Exemplary Embodiment 4.

In this example, a mobile phone carried by a user transmits behavior information of the user to the interest level measurement device 2 using an accelerometer equipped in the mobile phone. The interest level measurement device 2 calculates the user's interest level based on obtained acceleration data, and transmits the calculated interest level to a content server so that the interest level is used for selecting information distributed to the user.

Consider a situation where the user carrying the mobile phone enters a store. In this case, a GPS receiver and the accelerometer equipped in the mobile phone acquire position information and acceleration information of the user at a regular time interval. In this example, it is supposed that the area stay information acquisition/notification unit 21 is included in the mobile phone together with the GPS receiver.

When the user enters the store, the GPS receiver becomes incapable of positioning continuously for a fixed time period such as 30 seconds, as an example. This triggers the area stay information acquisition/notification unit 21 to determine a position at which the GPS receiver was capable of positioning last time, as a stay area. Let Tᵢₙ be a time at which the GPS receiver was capable of positioning last time, and t_{GPS} be a positioning time interval of the GPS receiver. The area stay information acquisition/notification unit 21 specifies a time Tᵢₙ+t_{GPS}/2 as a time at which the user enters the area, and acquires (calculates) the time as a stay start time. Meanwhile, the mobile phone transmits acceleration data from the stay start time onward, to the sensor data reception unit 21 in the interest level measurement device 2. The sensor data reception unit 21 supplies (outputs) sensor time-series data to the sensor data storage/reading unit 23, and the sensor data storage/reading unit 23 stores the received data in a database device.

Each time a fixed amount of acceleration data are accumulated, the mobile phone transmits the data to the sensor data reception unit 21. This is repeated until the GPS receiver becomes capable of positioning again. When the GPS receiver in the mobile phone becomes capable of positioning again, the area stay information acquisition/notification unit 22 compares latest position information and position information acquired immediately before the GPS receiver becomes incapable of positioning. In the case of determining that the latest position information matches, within a predetermined range such as 10 m, the position information acquired immediately before the GPS receiver becomes incapable of positioning, the area stay information acquisition/notification unit 22 assumes (determines) that the user stays in the area. Let Tₒᵤₜ be a time at which the GPS receiver becomes capable of positioning again. The area stay information acquisition/notification unit 22 specifies a time Tₒᵤₜ−t_{GPS}/2 as a time at which the user leaves the area, and acquires (calculates) the time as a stay end time. The mobile phone transmits sensor time-series data up to the stay end time, to the sensor data reception unit 21.

Since the sensor data storage/reading unit 23 stores the sensor time-series data for the stay time, the sensor data storage/reading unit 23 supplies (outputs) the sensor time-series data to the walking/stopping pattern creation unit 24. Here, the sensor data storage/reading unit 23 outputs, for example, acceleration data actually obtained using the mobile phone from when the user enters the store to when the user leaves the store as shown in FIG. 14.

The walking/stopping pattern creation unit 24 calculates an acceleration variance per second, based on the received accelerometer time-series data. Here, the walking/stopping pattern creation unit 24 calculates a variance as shown in FIG. 15 based on the acceleration data.

The walking/stopping pattern creation unit 24 creates a walking/stopping time-series pattern, by determining that the user is in a walking state in the case where the variance is not less than 1000 (mG)² and the user is in a stopping state in the case where the variance is less than 1000 (mG)². The walking/stopping pattern creation unit 24 supplies (outputs) the created walking/stopping time-series pattern to the behavior feature value calculation unit 25. Here, the walking/stopping pattern creation unit 24 outputs data obtained by binarizing the variance data shown in FIG. 15 according to the walking/stopping state, as shown in FIG. 16. In the example of the walking/stopping time-series pattern shown in FIG. 16, the walking state is set to 1 and the stopping state is set to 0.

The behavior feature value calculation unit 25 calculates, as a behavior feature value, the total walking time Tw and the total stopping time Ts within the stay time, based on the obtained walking/stopping time-series pattern. For instance, suppose the behavior feature value calculation unit 25 calculates Tw=470 (seconds) and Ts=505 (seconds) based on the walking/stopping time-series pattern, in the example shown in FIG. 16. The behavior feature value calculation unit 25 supplies (outputs) the obtained values of Tw and Ts to the area interest level determination unit 26.

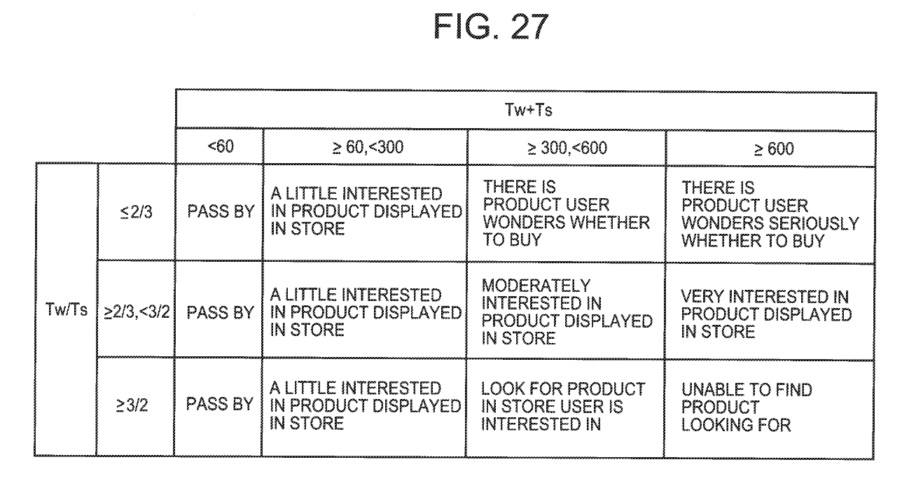

The area interest level determination unit 26 determines the user's area interest level using the received values of Tw and Ts based on, for example, a relationship between feature values and interest levels obtained from a result of an experiment conducted beforehand. FIG. 27 is a diagram showing an example of a table of such a relationship between behavior feature values and user interest levels. The area interest level determination unit 26 calculates Tw+Ts=975 and Tw/Ts=0.93, using Tw and Ts received from the behavior feature value calculation unit 25. The area interest level determination unit 26 accordingly determines that the user is very interested in a displayed product in the store, based on the table of the relationship shown in FIG. 27. The area interest level determination unit 26 supplies (outputs) the obtained interest level and the area stay information received from the area stay information acquisition/notification unit 22, to the interest level output device 3.

The interest level output device 3 transmits the user information and the area stay information and interest level information of the user, to the content server via a communication network. For example, the content server stores store information, store genre, prices of displayed products, and the like in a database device in association with area information, and has a function of searching for a product or a store of the same genre. Based on the area information and the interest level information indicating that the user is very interested in the store, which are received from the interest level output device 3, the content server searches for recommendation information relating to the same genre of store as the store in which the user stays and its product, and selects the recommendation information. The content server distributes the selected recommendation information to the mobile phone of the user via a communication network.

Here, a table of a relationship between feature values and interest levels that differs depending on the area may be prepared in advance, and stored in storage means (e.g. a storage device such as a magnetic disk device or a memory) by the area interest level determination unit 26 beforehand. The area interest level determination unit 26 may then determine the user's interest level, by selectively using the table of the relationship between feature values and interest levels based on the received stay area position information.

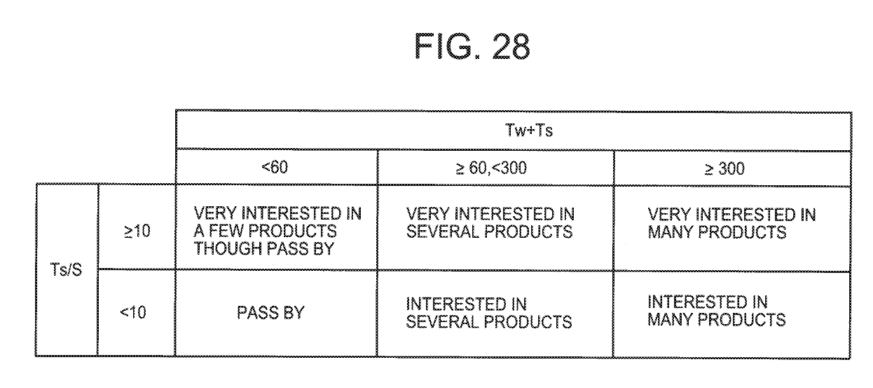

The table of the relationship between feature values and interest levels used for interest level determination is not limited to that shown in FIG. 27. For example, the area interest level determination unit 26 may determine the interest level using a table of another relationship between feature values and interest levels as shown in FIG. 28, or using a table of a plurality of relationships between feature values and interest levels. The area interest level determination unit 26 may also determine the interest level by more finely recognizing the degree and tendency of interest.

As described above, according to this example, through the use of the behavior feature value calculated from the walking/stopping time-series pattern of the user, the characteristics of the degree and tendency of interest that differ depending on the user, such as the purpose of visiting the store, the number of products the user is interested in, and the degree of interest, can be finely determined and recognized. This enables calculation of the fine interest level in each area by taking into account the degree and tendency of interest on a user basis.

### Example 5

Example 5 of the present invention is described below, with reference to drawings. An interest level measurement system in Example 5 corresponds to a more concrete example of the interest level measurement system in Exemplary Embodiment 5.

In this example as in Example 4, a mobile phone carried by a user transmits behavior information of the user to the interest level measurement device 2 using an accelerometer equipped in the mobile phone. The interest level measurement device 2 calculates the user's interest level based on obtained acceleration data, and transmits the calculated interest level to a content server so that the interest level is used for selecting information distributed to the user.

The process up to the creation of the walking/stopping pattern as a result of the user of the mobile phone entering and leaving the store is the same as the process in Example 4. It is supposed here that the walking/stopping pattern creation unit 24 calculates the same walking/stopping pattern as in FIG. 16.

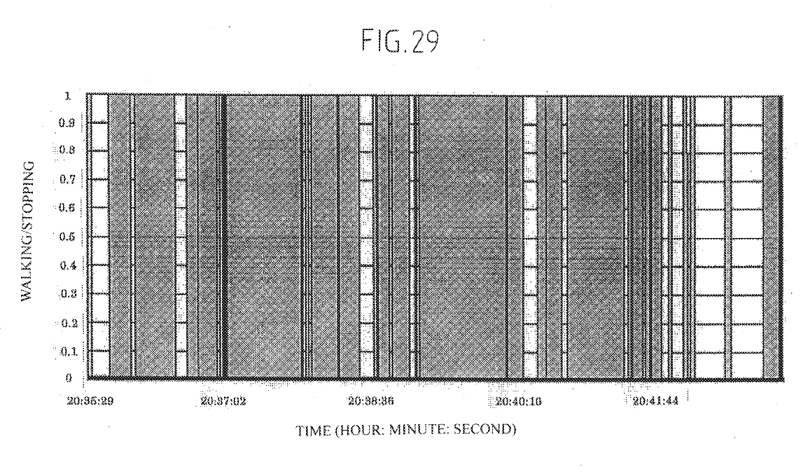

The area walking/stopping pattern storage/reading unit 27 stores the received walking/stopping time-series pattern in the database device together with the area stay information received from the area stay information acquisition/notification unit 22. The area walking/stopping pattern storage/reading unit 27 searches the history information stored in the database device for history information of the user's past stay in the same area. It is supposed here that the area walking/stopping pattern storage/reading unit 27 finds the history information of the user's past stay in the same area. It is also supposed that the area walking/stopping pattern storage/reading unit 27 finds a walking/stopping time-series pattern as shown in FIG. 29.

The area walking/stopping pattern storage/reading unit 27 supplies (outputs) the combination of the past walking/stopping time-series pattern and corresponding area stay information to the area behavior feature value calculation unit 251, in addition to the combination of the received latest area stay information and walking/stopping time-series pattern.

The area behavior feature value calculation unit 251 calculates, as a behavior feature value, the total walking time Tw and the total stopping time Ts within the stay time, based on the obtained walking/stopping time-series pattern. For instance, suppose the area behavior feature value calculation unit 251 calculates Tw₆=470 (seconds) and Ts₆=505 (seconds) based on the walking/stopping time-series pattern, in the example shown in FIG. 16. Also suppose the area behavior feature value calculation unit 251 calculates Tw₁₀=267 (seconds) and Ts₁₀=103 (seconds) based on the walking/stopping time-series pattern, in the example shown in FIG. 29. The area behavior feature value calculation unit 251 supplies (outputs) the obtained values of Tw and Ts to the area interest level determination unit 26.

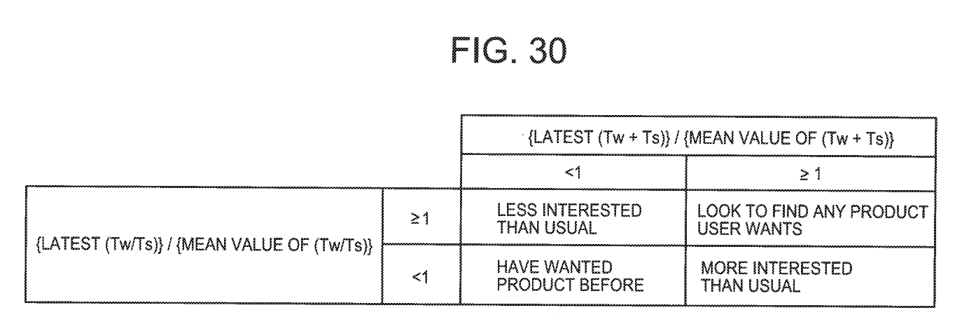

The area interest level determination unit 26 determines the user's area interest level using the received values of Tw and Ts based on, for example, a relationship between feature values and interest levels obtained from a result of an experiment conducted beforehand. FIGS. 27 and 30 are each a diagram showing an example of a table of such a relationship between behavior feature values and user interest levels. The area interest level determination unit 26 calculates Tw₆+Ts₆=975 (seconds), Tw₆/Ts₆=0.93, Tw₁₀+Ts₁₀=370 (seconds), and Tw₁₀/Ts₁₀=2.59, using Tw and Ts received from the area behavior feature value calculation unit 251. The area interest level determination unit 26 also calculates a mean value of (Tw+Ts) at 672.5 (seconds), and calculates a mean value of (Tw/Ts) at 1.76.

Since the latest Tw is Tw₆ and the latest Ts is Ts₆, the area interest level determination unit 26 determines that the user is very interested in a displayed product in the store, based on the above-mentioned calculation results and the tables of the relationships shown in FIGS. 27 and 30. In addition, through comparison with the user's average interest level obtained from the past history information, the area interest level determination unit 26 can determine that the user visits the store with more interest than usual. The area interest level determination unit 26 supplies (outputs) the obtained interest level and the area stay information to the interest level output device 3.

In this example, the process executed by the interest level output device 3 is the same as the process in Example 4.

Here, a table of a relationship between feature values and interest levels that differs depending on the area may be prepared in advance, and stored in storage means (e.g. a storage device such as a magnetic disk device or a memory) by the area interest level determination unit 26 beforehand, as in Example 4. The area interest level determination unit 26 may then determine the user's interest level, by selectively using the table of the relationship between feature values and interest levels based on the received stay area position information.

The area walking/stopping pattern storage/reading unit 27 may not necessarily search for and read the history information corresponding to when the user visited the same area. For example, the area walking/stopping pattern storage/reading unit 27 may read data corresponding to when the user visited another store dealing with a similar product, or data corresponding to when the user visited a nearby area.

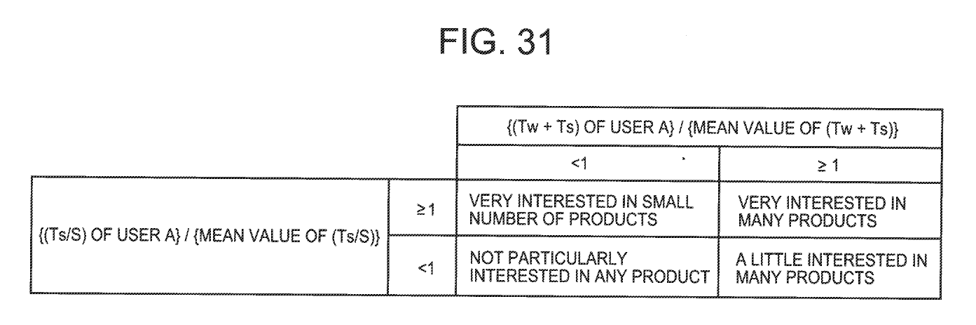

The tables of the relationship between feature values and interest levels used for interest level determination are not limited to those shown in FIGS. 27 and 30. For example, the area interest level determination unit 26 may determine the interest level using tables of another relationship between feature values and interest levels as shown in FIGS. 28 and 31, or using tables of a plurality of relationships between feature values and interest levels. The area interest level determination unit 26 may also determine the interest level by more finely recognizing the degree and tendency of interest.

As described above, according to this example, in addition to the advantageous effects of Example 4, the interest level measurement system can determine the user's interest level in each area stay with respect to his/her usual interest level, through the use of the past history information of the user. This enables fine interest level determination suitable for each individual, such as finding a different tendency of interest from usual or recognizing a time-series change of the degree of the user's interest.

### Example 6

Example 6 of the present invention is described below, with reference to drawings. An interest level measurement system in Example 6 corresponds to a more concrete example of the interest level measurement system in Exemplary Embodiment 6.

In this example as in Example 4, a mobile phone carried by a user transmits behavior information of the user to the interest level measurement device 2 using an accelerometer equipped in the mobile phone. The interest level measurement device 2 calculates the user's interest level based on obtained acceleration data, and transmits the calculated interest level to a content server so that the interest level is used for selecting information distributed to the user.

The process up to the creation of the walking/stopping pattern as a result of the user A who owns the mobile phone entering and leaving the store is the same as the process in Example 4. It is supposed here that the walking/stopping pattern creation unit 24 calculates the same walking/stopping pattern as in FIG. 16.

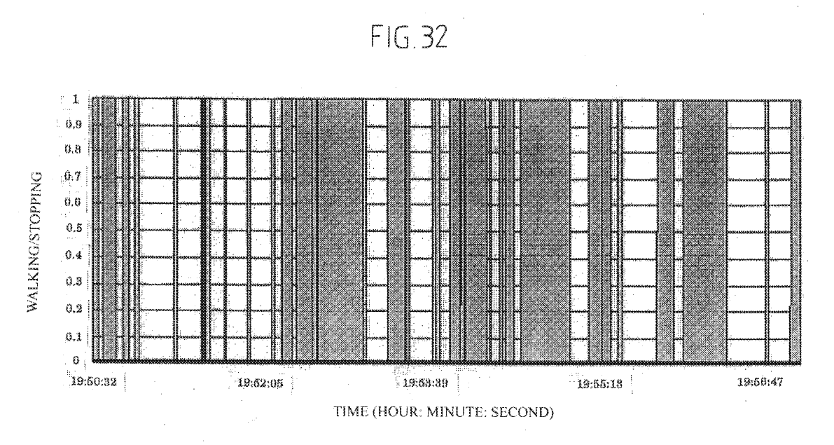

The user-specific walking/stopping pattern storage/reading unit 271 stores the received walking/stopping time-series pattern in the database device together with the area stay information received from the area stay information acquisition/notification unit 22. The user-specific walking/stopping pattern storage/reading unit 271 searches the history information stored in the database device for history information of a user, other than the user A, who stayed in the same area. It is supposed here that the user-specific walking/stopping pattern storage/reading unit 271 finds the history information of the user B who stayed in the same area. It is also supposed that the user-specific walking/stopping pattern storage/reading unit 271 finds a walking/stopping time-series pattern as shown in FIG. 32.

The user-specific walking/stopping pattern storage/reading unit 271 supplies (outputs) the combination of the walking/stopping time-series pattern of the user B shown in FIG. 32 and the corresponding area stay information to the area behavior feature value calculation unit 251, in addition to the combination of the area stay information and the walking/stopping time-series pattern of the user A.

The area behavior feature value calculation unit 251 calculates, as a behavior feature value, the total walking time Tw, the total stopping time Ts, and the stopping count S within the stay time, based on the obtained walking/stopping time-series pattern. For instance, suppose the area behavior feature value calculation unit 251 calculates Tw₆=470 (seconds), Ts₆=505 (seconds), and S₆=46 (times) based on the walking/stopping time-series pattern, in the example shown in FIG. 16. Also suppose the area behavior feature value calculation unit 251 calculates Tw₁₄=153 (seconds), Ts₁₄=167 (seconds), and S₁₄=26 (times) based on the walking/stopping time-series pattern, in the example shown in FIG. 32. The area behavior feature value calculation unit 251 supplies (outputs) the obtained values of Tw, Ts, and S to the area interest level determination unit 26.

The area interest level determination unit 26 determines the user A's area interest level using the received values of Tw, Ts, and S based on, for example, a relationship between feature values and interest levels obtained from a result of an experiment conducted beforehand. FIGS. 28 and 31 are each a diagram showing an example of a table of such a relationship between behavior feature values and user interest levels. The area interest level determination unit 26 calculates Tw₆+Ts₆=975 (seconds), Ts₆/S₆=10.9 (seconds), Tw₁₄+Ts₁₄=320 (seconds), and Ts₁₄/S₁₄=6.4 (seconds), using Tw and Ts received from the area behavior feature value calculation unit 251. The area interest level determination unit 26 can accordingly determine that the user A is very interested in many products, based on the table of the relationship between behavior feature values and interest levels shown in FIG. 28.

The area interest level determination unit 26 also calculates a mean value of (Tw+Ts) at 647.5 (seconds), and calculates a mean value of (Ts/S) at 8.65 (seconds). The area interest level determination unit 26 can accordingly determine that the user A is very interested in more products than an average user, as a result of comparing the user A's behavior feature value and the average behavior feature value of users based on the table of the relationship between behavior feature values and interest levels shown in FIG. 31. The area interest level determination unit 26 supplies (outputs) the obtained interest level and the area stay information to the interest level output device 3.

In this example, the process executed by the interest level output device 3 is the same as the process in Example 4.

Here, a table of a relationship between feature values and interest levels that differs depending on the area may be prepared in advance, and stored in storage means (e.g. a storage device such as a magnetic disk device or a memory) by the area interest level determination unit 26 beforehand, as in Example 4. The area interest level determination unit 26 may then determine the user's interest level, by selectively using the table of the relationship between feature values and interest levels based on the received stay area position information.

The user-specific walking/stopping pattern storage/reading unit 271 may store past history information of all users including the user A in the database device so that the area behavior feature value calculation unit 251 calculates the feature value by simultaneously using the past history information of the user A and the history information of any user other than the user A.

The tables of the relationship between feature values and interest levels used for interest level determination are not limited to those shown in FIGS. 28 and 31. For example, the area interest level determination unit 26 may determine the interest level using the tables of another relationship between feature values and interest levels as shown in FIGS. 27 and 30, or using tables of a plurality of relationships between feature values and interest levels. The area interest level determination unit 26 may also determine the interest level by more finely recognizing the degree and tendency of interest.

As described above, according to this example, in addition to the advantageous effects of Example 4, the interest level measurement system can perform comparison with the average interest level through the use of the walking/stopping time-series pattern of another user. Thus, the similarity between the plurality of users and the specificity of the specific user can be extracted, and also the feature value such as the relative degree of interest in comparison between the plurality of users can be extracted. This enables objective and fine interest level determination.

Though each of the above exemplary embodiments and examples describes the case where the sensor terminal 1 includes an accelerometer, the sensor terminal 1 may include a sensor other than an accelerometer. Besides, the sensor terminal 1 may include not only one sensor but a plurality of sensors. In the case of including a plurality of sensors, the sensor terminal 1 may include, for example, an electromagnetic compass together with a gyroscope. In this case, for example, the sensor terminal 1 may detect an angular velocity using the gyroscope so that the interest level measurement device 2 determines, based on the angular velocity from the sensor terminal 1, whether the user is in a walking state or a stopping state or whether or not the user is in a state of a non-walking behavior. The sensor terminal 1 may also detect the posture of the sensor terminal 1 using the electromagnetic compass so that the interest level measurement device 2 determines the posture of the sensor terminal 1 based on the detection result of the electromagnetic compass from the sensor terminal 1.

Note, however, that, the inclusion of the accelerometer in the sensor terminal 1 as in each of the above exemplary embodiments and examples enables the interest level measurement device 2 to determine whether the user is in a walking state, a stopping state, or a state of a non-walking behavior based on the acceleration, and also determine the posture of the sensor terminal 1 by calculating the gravity vector based on the acceleration. That is, the inclusion of only one sensor is sufficient to recognize the detailed behavior status of the user and determine the interest level. This contributes to lower cost of the sensor terminal 1.

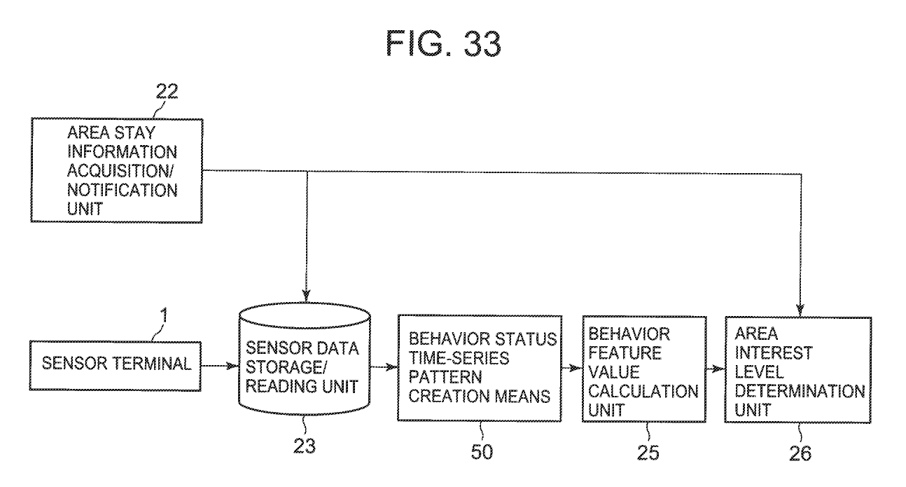

The following describes a minimum structure of an interest level measurement system according to the present invention. FIG. 33 is a block diagram showing an example of the minimum structure of the interest level measurement system. As shown in FIG. 33, the interest level measurement system includes the sensor terminal 1, the area stay information acquisition/notification unit 22, the sensor data storage/reading unit 23, behavior status time-series pattern creation means 50, the behavior feature value calculation unit 25, and the area interest level determination unit 26, as minimum components. The behavior status time-series pattern creation means 50 corresponds to, for example, the non-walking behavior pattern creation unit 28 in Exemplary Embodiment 1 or the terminal posture pattern creation unit 29 in Exemplary Embodiment 2.

In the interest level measurement system of the minimum structure shown in FIG. 33, the sensor terminal 1 has a function of acquiring data that indicates an action state of a user. The area stay information acquisition/notification unit 22 has a function of acquiring area stay information that includes position information of an area in which the user stays and stay time information of a time during which the user stays in the area. The sensor data storage/reading unit 23 has a function of storing the data acquired by the sensor terminal 1, and reading the stored data according to the area stay information acquired by the area stay information acquisition/notification unit 22. The behavior status time-series pattern creation means 50 has a function of determining a behavior status of the user based on the data read by the sensor data storage/reading unit 23, and creating a behavior status time-series pattern that indicates the behavior status of the user. The behavior feature value calculation unit 25 has a function of calculating a behavior feature value indicating a feature of a behavior of the user based on the behavior status time-series pattern created by the behavior status time-series pattern creation means 50. The area interest level determination unit 26 has a function of determining an area interest level that indicates a degree and tendency of the user's interest in the area, using the behavior feature value calculated by the behavior feature value calculation unit 25.

According to the interest level measurement system of the minimum structure shown in FIG. 33, the detailed behavior status of the user can be recognized to calculate the fine interest level in each area by taking into account the degree and tendency of interest on a user basis.

The characteristic structures of the interest level measurement system and the interest level measurement device as in the following (1) to (22) are described in the above exemplary embodiments and examples.

(1) An interest level measurement system comprises: a user terminal (e.g. the sensor terminal 1) for acquiring data that indicates an action state of a user; area stay information acquisition means (e.g. realized by the area stay information acquisition/notification unit 22) for acquiring area stay information that includes position information of an area in which the user stays and stay time information of a time during which the user stays in the area; data storage/reading means (e.g. realized by the sensor data storage/reading unit 23) for storing the data acquired by the user terminal, and reading the stored data according to the area stay information acquired by the area stay information acquisition means; behavior status time-series pattern creation means (e.g. realized by the non-walking behavior pattern creation unit 28, the terminal posture pattern creation unit 29) for determining a behavior status of the user based on the data read by the data storage/reading means, and creating a behavior status time-series pattern (e.g. the non-walking behavior time-series pattern, the terminal posture time-series pattern) that indicates the behavior status of the user; behavior feature value calculation means (e.g. realized by the behavior feature value calculation unit 25) for calculating a behavior feature value that indicates a feature of a behavior of the user, based on the behavior status time-series pattern created by the behavior status time-series pattern creation means; and area interest level determination means (e.g. realized by the area interest level determination unit 26) for determining an area interest level that indicates a degree and tendency of the user's interest in the area, using the behavior feature value calculated by the behavior feature value calculation means.
(2) In the interest level measurement system, the behavior status time-series pattern creation means may determine whether or not the user is in a state of a behavior other than walking based on the data read by the data storage/reading means, and create, as the behavior status time-series pattern, a non-walking behavior time-series pattern indicating that the user is in the state of the behavior other than walking, wherein the behavior feature value calculation means calculates the behavior feature value, based on the non-walking behavior time-series pattern created by the behavior status time-series pattern creation means.
(3) In the interest level measurement system, the behavior status time-series pattern creation means may determine a posture of the user terminal based on the data read by the data storage/reading means, and create, as the behavior status time-series pattern, a terminal posture time-series pattern indicating the posture of the user terminal, wherein the behavior feature value calculation means calculates the behavior feature value, based on the terminal posture time-series pattern created by the behavior status time-series pattern creation means.
(4) The interest level measurement system may comprise environment information acquisition means (e.g. realized by the environment information acquisition/communication unit 40) for acquiring environment information that indicates an environment in the area in which the user stays, wherein the area interest level determination means determines the area interest level, using the behavior feature value calculated by the behavior feature value calculation means and the environment information acquired by the environment information acquisition means.
(5) In the interest level measurement system, the user terminal may include an accelerometer, and use the accelerometer to acquire acceleration data as the data that indicates the action state of the user, wherein the behavior status time-series pattern creation means determines whether or not an acceleration peak interval is within a predetermined range based on the acceleration data read by the data storage/reading means and, in the case of determining that the acceleration peak interval is not within the predetermined range, determines that the user is in the state of the behavior other than walking.
(6) In the interest level measurement system, the user terminal may include an accelerometer, and use the accelerometer to acquire acceleration data as the data that indicates the action state of the user, wherein the behavior status time-series pattern creation means determines the posture of the user terminal by calculating a gravity vector as data that indicates the posture of the user terminal, based on the acceleration data read by the data storage/reading means.
(7) In the interest level measurement system, the behavior feature value calculation means may calculate, as the behavior feature value, a similarity between the posture of the user terminal indicated by the terminal posture time-series pattern created by the behavior status time-series pattern creation means and a predetermined reference posture.
(8) In the interest level measurement system, the behavior feature value calculation means may calculate, as the behavior feature value, a variance of the gravity vector calculated by the behavior status time-series pattern creation means.
(9) In the interest level measurement system, the environment information acquisition means may acquire, as the environment information, the number of people in the area in which the user stays, a temperature in the area, or a humidity in the area.
(10) The interest level measurement system may comprise walking/stopping pattern creation means (e.g. realized by the walking/stopping pattern creation unit 24) for determining whether the user is in a walking state or a stopping state based on the data read by the data storage/reading means, and creating a walking/stopping time-series pattern indicating whether the user is in the walking state or the stopping state, wherein the behavior feature value calculation means calculates the behavior feature value based on the behavior status time-series pattern created by the behavior status time-series pattern creation means and the walking/stopping time-series pattern created by the walking/stopping pattern creation means.
(11) An interest level measurement device (e.g. the interest level measurement device 2) comprises: area stay information acquisition means (e.g. realized by the area stay information acquisition/notification unit 22) for acquiring area stay information that includes position information of an area in which a user stays and stay time information of a time during which the user stays in the area; data storage/reading means (e.g. realized by the sensor data storage/reading unit 23) for storing data acquired by a user terminal and indicating an action state of the user, and reading the stored data according to the area stay information acquired by the area stay information acquisition means; behavior status time-series pattern creation means (e.g. realized by the non-walking behavior pattern creation unit 28, the terminal posture pattern creation unit 29) for determining a behavior status of the user based on the data read by the data storage/reading means, and creating a behavior status time-series pattern (e.g. the non-walking behavior time-series pattern, the terminal posture time-series pattern) that indicates the behavior status of the user; behavior feature value calculation means (e.g. realized by the behavior feature value calculation unit 25) for calculating a behavior feature value that indicates a feature of a behavior of the user, based on the behavior status time-series pattern created by the behavior status time-series pattern creation means; and area interest level determination means (e.g. realized by the area interest level determination unit 26) for determining an area interest level that indicates a degree and tendency of the user's interest in the area, using the behavior feature value calculated by the behavior feature value calculation means.
(12) An interest level measurement system comprises: a user terminal for acquiring data that indicates an action state of a user; an area stay information acquisition unit for acquiring area stay information that includes position information of an area in which the user stays and stay time information of a time during which the user stays in the area; a data storage/reading unit for storing the data acquired by the user terminal, and reading the stored data according to the area stay information acquired by the area stay information acquisition unit; a behavior status time-series pattern creation unit for determining a behavior status of the user based on the data read by the data storage/reading unit, and creating a behavior status time-series pattern that indicates the behavior status of the user; a behavior feature value calculation unit for calculating a behavior feature value that indicates a feature of a behavior of the user, based on the behavior status time-series pattern created by the behavior status time-series pattern creation unit; and an area interest level determination unit for determining an area interest level that indicates a degree and tendency of the user's interest in the area, using the behavior feature value calculated by the behavior feature value calculation unit.
(13) In the interest level measurement system, the behavior status time-series pattern creation unit may determine whether or not the user is in a state of a behavior other than walking based on the data read by the data storage/reading unit, and create, as the behavior status time-series pattern, a non-walking behavior time-series pattern indicating that the user is in the state of the behavior other than walking, wherein the behavior feature value calculation unit calculates the behavior feature value, based on the non-walking behavior time-series pattern created by the behavior status time-series pattern creation unit.
(14) In the interest level measurement system, the behavior status time-series pattern creation unit may determine a posture of the user terminal based on the data read by the data storage/reading unit, and create, as the behavior status time-series pattern, a terminal posture time-series pattern indicating the posture of the user terminal, wherein the behavior feature value calculation unit calculates the behavior feature value, based on the terminal posture time-series pattern created by the behavior status time-series pattern creation unit.
(15) The interest level measurement system may comprise an environment information acquisition unit for acquiring environment information that indicates an environment in the area in which the user stays, wherein the area interest level determination unit determines the area interest level, using the behavior feature value calculated by the behavior feature value calculation unit and the environment information acquired by the environment information acquisition unit.
(16) In the interest level measurement system, the user terminal may include an accelerometer, and use the accelerometer to acquire acceleration data as the data that indicates the action state of the user, wherein the behavior status time-series pattern creation unit determines whether or not an acceleration peak interval is within a predetermined range based on the acceleration data read by the data storage/reading unit and, in the case of determining that the acceleration peak interval is not within the predetermined range, determines that the user is in the state of the behavior other than walking.
(17) In the interest level measurement system, the user terminal may include an accelerometer, and use the accelerometer to acquire acceleration data as the data that indicates the action state of the user, wherein the behavior status time-series pattern creation unit determines the posture of the user terminal by calculating a gravity vector as data that indicates the posture of the user terminal, based on the acceleration data read by the data storage/reading unit.
(18) In the interest level measurement system, the behavior feature value calculation unit may calculate, as the behavior feature value, a similarity between the posture of the user terminal indicated by the terminal posture time-series pattern created by the behavior status time-series pattern creation unit and a predetermined reference posture.
(19) In the interest level measurement system, the behavior feature value calculation unit may calculate, as the behavior feature value, a variance of the gravity vector calculated by the behavior status time-series pattern creation unit.
(20) In the interest level measurement system, the environment information acquisition unit may acquire, as the environment information, the number of people in the area in which the user stays, a temperature in the area, or a humidity in the area.
(21) The interest level measurement system may comprise a walking/stopping pattern creation unit for determining whether the user is in a walking state or a stopping state based on the data read by the data storage/reading unit, and creating a walking/stopping time-series pattern indicating whether the user is in the walking state or the stopping state, wherein the behavior feature value calculation unit calculates the behavior feature value based on the behavior status time-series pattern created by the behavior status time-series pattern creation unit and the walking/stopping time-series pattern created by the walking/stopping pattern creation unit.
(22) An interest level measurement device comprises: an area stay information acquisition unit for acquiring area stay information that includes position information of an area in which a user stays and stay time information of a time during which the user stays in the area; a data storage/reading unit for storing data acquired by a user terminal and indicating an action state of the user, and reading the stored data according to the area stay information acquired by the area stay information acquisition unit; a behavior status time-series pattern creation unit for determining a behavior status of the user based on the data read by the data storage/reading unit, and creating a behavior status time-series pattern that indicates the behavior status of the user; a behavior feature value calculation unit for calculating a behavior feature value that indicates a feature of a behavior of the user, based on the behavior status time-series pattern created by the behavior status time-series pattern creation unit; and an area interest level determination unit for determining an area interest level that indicates a degree and tendency of the user's interest in the area, using the behavior feature value calculated by the behavior feature value calculation unit.

Part or whole of each of the above exemplary embodiments and examples may be described as in the following supplementary notes, but is not limited to such.

(Supplementary note 1) An interest level measurement system comprising: a user terminal for acquiring data that indicates an action state of a user; area stay information acquisition means for acquiring area stay information that includes position information of an area in which the user stays and stay time information of a time during which the user stays in the area; data storage/reading means for storing the data acquired by the user terminal, and reading the stored data according to the area stay information acquired by the area stay information acquisition means; behavior status time-series pattern creation means for determining a behavior status of the user based on the data read by the data storage/reading means, and creating a behavior status time-series pattern that indicates the behavior status of the user; behavior feature value calculation means for calculating a behavior feature value that indicates a feature of a behavior of the user, based on the behavior status time-series pattern created by the behavior status time-series pattern creation means; and area interest level determination means for determining an area interest level that indicates a degree and tendency of the user's interest in the area, using the behavior feature value calculated by the behavior feature value calculation means.
(Supplementary note 2) The interest level measurement system according to supplementary note 1, wherein the behavior status time-series pattern creation means determines whether or not the user is in a state of a behavior other than walking based on the data read by the data storage/reading means, and creates, as the behavior status time-series pattern, a non-walking behavior time-series pattern indicating that the user is in the state of the behavior other than walking, and wherein the behavior feature value calculation means calculates the behavior feature value, based on the non-walking behavior time-series pattern created by the behavior status time-series pattern creation means.
(Supplementary note 3) The interest level measurement system according to supplementary note 1 or 2, wherein the behavior status time-series pattern creation means determines a posture of the user terminal based on the data read by the data storage/reading means, and creates, as the behavior status time-series pattern, a terminal posture time-series pattern indicating the posture of the user terminal, and wherein the behavior feature value calculation means calculates the behavior feature value, based on the terminal posture time-series pattern created by the behavior status time-series pattern creation means.
(Supplementary note 4) The interest level measurement system according to any one of supplementary notes 1 to 3, comprising environment information acquisition means for acquiring environment information that indicates an environment in the area in which the user stays, wherein the area interest level determination means determines the area interest level, using the behavior feature value calculated by the behavior feature value calculation means and the environment information acquired by the environment information acquisition means.
(Supplementary note 5) The interest level measurement system according to supplementary note 2, wherein the user terminal includes an accelerometer, and uses the accelerometer to acquire acceleration data as the data that indicates the action state of the user, and wherein the behavior status time-series pattern creation means determines whether or not an acceleration peak interval is within a predetermined range based on the acceleration data read by the data storage/reading means and, in the case of determining that the acceleration peak interval is not within the predetermined range, determines that the user is in the state of the behavior other than walking.
(Supplementary note 6) The interest level measurement system according to supplementary note 3, wherein the user terminal includes an accelerometer, and uses the accelerometer to acquire acceleration data as the data that indicates the action state of the user, and wherein the behavior status time-series pattern creation means determines the posture of the user terminal by calculating a gravity vector as data that indicates the posture of the user terminal, based on the acceleration data read by the data storage/reading means.
(Supplementary note 7) The interest level measurement system according to supplementary note 3 or 6, wherein the behavior feature value calculation means calculates, as the behavior feature value, a similarity between the posture of the user terminal indicated by the terminal posture time-series pattern created by the behavior status time-series pattern creation means and a predetermined reference posture.
(Supplementary note 8) The interest level measurement system according to supplementary note 6, wherein the behavior feature value calculation means calculates, as the behavior feature value, a variance of the gravity vector calculated by the behavior status time-series pattern creation means.
(Supplementary note 9) The interest level measurement system according to supplementary note 4, wherein the environment information acquisition means acquires, as the environment information, the number of people in the area in which the user stays, a temperature in the area, or a humidity in the area.
(Supplementary note 10) The interest level measurement system according to any one of supplementary notes 1 to 9, comprising walking/stopping pattern creation means for determining whether the user is in a walking state or a stopping state based on the data read by the data storage/reading means, and creating a walking/stopping time-series pattern indicating whether the user is in the walking state or the stopping state, wherein the behavior feature value calculation means calculates the behavior feature value based on the behavior status time-series pattern created by the behavior status time-series pattern creation means and the walking/stopping time-series pattern created by the walking/stopping pattern creation means.
(Supplementary note 11) An interest level measurement device comprising: area stay information acquisition means for acquiring area stay information that includes position information of an area in which a user stays and stay time information of a time during which the user stays in the area; data storage/reading means for storing data acquired by a user terminal and indicating an action state of the user, and reading the stored data according to the area stay information acquired by the area stay information acquisition means; behavior status time-series pattern creation means for determining a behavior status of the user based on the data read by the data storage/reading means, and creating a behavior status time-series pattern that indicates the behavior status of the user; behavior feature value calculation means for calculating a behavior feature value that indicates a feature of a behavior of the user, based on the behavior status time-series pattern created by the behavior status time-series pattern creation means; and area interest level determination means for determining an area interest level that indicates a degree and tendency of the user's interest in the area, using the behavior feature value calculated by the behavior feature value calculation means.
(Supplementary note 12) An interest level measurement method comprising: acquiring, by a user terminal, data that indicates an action state of a user; acquiring area stay information that includes position information of an area in which the user stays and stay time information of a time during which the user stays in the area; storing the data acquired by the user terminal, and reading the stored data according to the acquired area stay information; determining a behavior status of the user based on the read data, and creating a behavior status time-series pattern that indicates the behavior status of the user; calculating a behavior feature value that indicates a feature of a behavior of the user, based on the created behavior status time-series pattern; and determining an area interest level that indicates a degree and tendency of the user's interest in the area, using the calculated behavior feature value.
(Supplementary note 13) An interest level measurement program for causing a computer to execute: a process of acquiring area stay information that includes position information of an area in which a user stays and stay time information of a time during which the user stays in the area; a process of storing data acquired by a user terminal and indicating an action state of the user, and reading the stored data according to the acquired area stay information; a process of determining a behavior status of the user based on the read data, and creating a behavior status time-series pattern that indicates the behavior status of the user; a process of calculating a behavior feature value that indicates a feature of a behavior of the user, based on the created behavior status time-series pattern; and a process of determining an area interest level that indicates a degree and tendency of the user's interest in the area, using the calculated behavior feature value.

While the present invention has been described with reference to the above exemplary embodiments and examples, the present invention is not limited to the above exemplary embodiments and examples. Various changes understandable by those skilled in the art within the scope of the present invention can be made to the structures and details of the present invention.

This application claims priority based on Japanese Patent Application No. 2010-59750 filed on Mar. 16, 2010, the disclosure of which is incorporated herein in its entirety.

### INDUSTRIAL APPLICABILITY

The present invention is applicable to use of an interest level measurement system for measuring a user's interest level in an area.

### REFERENCE SIGNS LIST

1 sensor terminal
2 interest level measurement device
3 interest level output device
21 sensor data reception unit
22 area stay information acquisition/notification unit
23, 23A sensor data storage/reading unit
24 walking/stopping pattern creation unit
25, 25A behavior feature value calculation unit
26, 26A, 26B area interest level determination unit
27 area walking/stopping pattern storage/reading unit
28 non-walking behavior pattern creation unit
29 terminal posture pattern creation unit
40 environment information acquisition/communication unit
50 behavior status time-series pattern creation means
251 area behavior feature value calculation unit
271 user-specific walking/stopping pattern storage/reading unit

1-10. (canceled)

11. An interest level measurement system comprising:
a user terminal for acquiring data that indicates an action state of a user;
area stay information acquisition unit for acquiring area stay information that includes position information of an area in which the user stays and stay time information of a time during which the user stays in the area;
data storage/reading unit for storing the data acquired by the user terminal, and reading the stored data according to the area stay information acquired by the area stay information acquisition unit;
behavior status time-series pattern creation unit for determining a behavior status of the user based on the data read by the data storage/reading unit, and creating a behavior status time-series pattern that indicates the behavior status of the user;
behavior feature value calculation unit for calculating a behavior feature value that indicates a feature of a behavior of the user, based on the behavior status time-series pattern created by the behavior status time-series pattern creation unit; and
area interest level determination unit for determining an area interest level that indicates a degree and tendency of the user's interest in the area, using the behavior feature value calculated by the behavior feature value calculation unit.

12. The interest level measurement system according to claim 11, wherein the behavior status time-series pattern creation unit determines whether or not the user is in a state of a behavior other than walking based on the data read by the data storage/reading unit, and creates, as the behavior status time-series pattern, a non-walking behavior time-series pattern indicating that the user is in the state of the behavior other than walking, and
wherein the behavior feature value calculation unit calculates the behavior feature value, based on the non-walking behavior time-series pattern created by the behavior status time-series pattern creation unit.

13. The interest level measurement system according to claim 11, wherein the behavior status time-series pattern creation unit determines a posture of the user terminal based on the data read by the data storage/reading unit, and creates, as the behavior status time-series pattern, a terminal posture time-series pattern indicating the posture of the user terminal, and
wherein the behavior feature value calculation unit calculates the behavior feature value, based on the terminal posture time-series pattern created by the behavior status time-series pattern creation unit.

14. The interest level measurement system according to any one of claim 11, comprising
environment information acquisition unit for acquiring environment information that indicates an environment in the area in which the user stays,
wherein the area interest level determination unit determines the area interest level, using the behavior feature value calculated by the behavior feature value calculation unit and the environment information acquired by the environment information acquisition unit.

15. The interest level measurement system according to claim 12, wherein the user terminal includes an accelerometer, and uses the accelerometer to acquire acceleration data as the data that indicates the action state of the user, and
wherein the behavior status time-series pattern creation unit determines whether or not an acceleration peak interval is within a predetermined range based on the acceleration data read by the data storage/reading unit and, in the case of determining that the acceleration peak interval is not within the predetermined range, determines that the user is in the state of the behavior other than walking.

16. The interest level measurement system according to claim 13, wherein the user terminal includes an accelerometer, and uses the accelerometer to acquire acceleration data as the data that indicates the action state of the user, and
wherein the behavior status time-series pattern creation unit determines the posture of the user terminal by calculating a gravity vector as data that indicates the posture of the user terminal, based on the acceleration data read by the data storage/reading unit.

17. The interest level measurement system according to claim 13, wherein the behavior feature value calculation unit calculates, as the behavior feature value, a similarity between the posture of the user terminal indicated by the terminal posture time-series pattern created by the behavior status time-series pattern creation unit and a predetermined reference posture.

18. An interest level measurement device comprising:
area stay information acquisition unit for acquiring area stay information that includes position information of an area in which a user stays and stay time information of a time during which the user stays in the area;
data storage/reading unit for storing data acquired by a user terminal and indicating an action state of the user, and reading the stored data according to the area stay information acquired by the area stay information acquisition unit;
behavior status time-series pattern creation unit for determining a behavior status of the user based on the data read by the data storage/reading unit, and creating a behavior status time-series pattern that indicates the behavior status of the user;
behavior feature value calculation unit for calculating a behavior feature value that indicates a feature of a behavior of the user, based on the behavior status time-series pattern created by the behavior status time-series pattern creation unit; and
area interest level determination unit for determining an area interest level that indicates a degree and tendency of the user's interest in the area, using the behavior feature value calculated by the behavior feature value calculation unit.

19. An interest level measurement method comprising:
acquiring, by a user terminal, data that indicates an action state of a user;
acquiring area stay information that includes position information of an area in which the user stays and stay time information of a time during which the user stays in the area;
storing the data acquired by the user terminal, and reading the stored data according to the acquired area stay information;
determining a behavior status of the user based on the read data, and creating a behavior status time-series pattern that indicates the behavior status of the user;
calculating a behavior feature value that indicates a feature of a behavior of the user, based on the created behavior status time-series pattern; and
determining an area interest level that indicates a degree and tendency of the user's interest in the area, using the calculated behavior feature value.

20. A computer readable information recording medium storing an interest level measurement program, when executed by a processor, performs a method for:
acquiring area stay information that includes position information of an area in which a user stays and stay time information of a time during which the user stays in the area;
storing data acquired by a user terminal and indicating an action state of the user, and reading the stored data according to the acquired area stay information;
determining a behavior status of the user based on the read data, and creating a behavior status time-series pattern that indicates the behavior status of the user;
calculating a behavior feature value that indicates a feature of a behavior of the user, based on the created behavior status time-series pattern; and
determining an area interest level that indicates a degree and tendency of the user's interest in the area, using the calculated behavior feature value.
